(19) United States
(12) Patent Application Publication
(10) Pub. No.: US 2026/0139537 A1
(43) Pub. Date: May 21, 2026

(54) POWERED DOOR UNIT OPTIMIZED FOR SERVO CONTROL

(71) Applicant: Magna Closures Inc., Newmarket (CA)

(72) Inventors: Jube Raymond Leonard, Newmarket (CA); Saikat Bose, Newmarket (CA)

(21) Appl. No.: 19/449,782

(22) Filed: Jan. 15, 2026

Related U.S. Application Data
(63) Continuation of application No. 17/762,391, now abandoned.
(60) Provisional application No. 62/929,261, filed on Nov. 1, 2019.
(60) Provisional application No. 62/944,022, filed on Dec. 5, 2019.

(51) Int. Cl. E05F 15/622

(52) U.S. Cl. CPC E05F 15/622; E05Y 2201/434; E05Y 2201/70; E05Y 2201/702; E05Y 2400/32; E05Y 2800/12; E05Y 2900/531

(57) ABSTRACT

A powered actuator includes a leadscrew as an extensible member connected to a closure, such as a vehicle side door, and is configured to move linearly for opening or closing the closure. The first powered actuator also includes a gearbox having a gearbox housing, the gearbox configured to apply a force to the extensible member for causing the extensible member to move linearly. One or more sealing assembly seals the gearbox housing as the extensible member translates linearly. A gearbox housing may include apertures on opposite sides thereof, with one aperture facing a shut face and the other aperture facing an inner cavity of the closure. The extensible member may be sealed at each aperture relative to the gearbox housing. One sealing assembly may be fixed at an aperture, with the extensible member translating therethrough.

### CROSS REFERENCE TO RELATED APPLICATIONS

The present application is a Continuation of U.S. patent application Ser. No. 17/762,391, filed on Mar. 22, 2022, which is a United States National Stage of International Application No. PCT/CA2020/051473, filed on Oct. 30, 2020 which claims the benefit of previously filed U.S. Provisional Application No. 62/929,261, filed on Nov. 1, 2019, and U.S. Provisional Application No. 62/944,022, filed on Dec. 5, 2019, the contents of which are hereby incorporated by reference in their entirety herein.

### FIELD

The present disclosure relates to a power actuator for a vehicle closure. More specifically, the present disclosure relates to a power actuator assembly for a vehicle side door.

### BACKGROUND

This section provides background information related to the present disclosure which is not necessarily prior art.

Closure members of motor vehicles may be mounted by one or more hinges to the vehicle body. For example, passenger doors may be oriented and attached to the vehicle body by the one or more hinges for swinging movement about a generally vertical pivot axis. In such an arrangement, each door hinge typically includes a door hinge strap connected to the passenger door, a body hinge strap connected to the vehicle body, and a pivot pin arranged to pivotably connect the door hinge strap to the body hinge strap and define a pivot axis. Such swinging passenger doors (“swing doors”) may be moveable by power closure member actuation systems. Specifically, the power closure member system can function to automatically swing the passenger door about its pivot axis between the open and closed positions, to assist the user as he or she moves the passenger door, and/or to automatically move the passenger door in between closed and open positions for the user.

Typically, power closure member actuation systems include a power-operated device such as, for example, an electric motor and a rotary-to-linear conversion device that are operable for converting the rotary output of the electric motor into translational movement of an extensible member. In many arrangements, the electric motor and the conversion device are mounted to the passenger door and the distal end of the extensible member is fixedly secured to the vehicle body. One example of a power closure member actuation system for a passenger door is shown in commonly-owned International Publication No. WO2013/013313 to Scheuring et al. which discloses use of a rotary-to-linear conversion device having an externally-threaded leadscrew rotatively driven by the electric motor and an internally-threaded drive nut meshingly engaged with the leadscrew and to which the extensible member is attached. Accordingly, control over the speed and direction of rotation of the leadscrew results in control over the speed and direction of translational movement of the drive nut and the extensible member for controlling swinging movement of the passenger door between its open and closed positions.

A high-resolution position sensor, such as a magnet wheel and a Hall effect sensor, may be used to accurately measure a position in a power closure actuation sensor. However, such high-resolution sensors can be adversely affected by electromagnetic (EM) interference, such as may be generated by an EM brake.

In view of the above, there remains a need to develop power closure member actuation systems which address and overcome limitations and drawbacks associated with known power closure member actuation systems as well as to provide increased convenience and enhanced operational capabilities.

### SUMMARY

This section provides a general summary of the disclosure, and is not a comprehensive disclosure of its full scope or all of its features.

It is an object of the present disclosure to provide a powered actuator for a closure of a vehicle. Specifically, the powered actuator includes an electric motor configured to rotate a driven shaft, an extensible member configured to be coupled to one of a body or the closure of the vehicle for opening or closing the closure, a gearbox configured apply a force to the extensible member for causing the extensible member to move linearly in response to rotation of the driven shaft, and a high-resolution position sensor coupled to the driven shaft and configured to detect a position of the driven shaft.

In one aspect, the actuator includes a door adapter bracket configured for mounting to a sheet metal portion of a shut face of the body or closure, wherein the motor and gearbox are disposed adjacent the sheet metal portion when the door adapter bracket is installed, and wherein the extensible member is coupled to the body or closure without a linkage to reduce a distance between a center of mass of the actuator and sheet metal portion of the shut face.

In one aspect, the high-resolution position sensor comprises a magnet wheel and a Hall effect sensor.

In one aspect, the high-resolution position sensor is directly coupled to the driven shaft.

In one aspect, the actuator includes an electromagnetic brake configured to apply a braking force to the driven shaft; wherein the electromagnetic brake is decoupled from the high-resolution position sensor such that an electromagnetic field generated by the electromagnetic brake does not interfere with the high-resolution position sensor.

In one aspect, the electromagnetic brake is spaced away from the high-resolution position sensor such that the electromagnetic field generated by the electromagnetic brake does not interfere with the high-resolution position sensor.

In one aspect, the gearbox is disposed between the electromagnetic brake and the high-resolution position sensor.

In one aspect, the actuator includes an electromagnetic shied disposed between the electromagnetic brake and the high-resolution position sensor, the electromagnetic shied configured to prevent the electromagnetic fields generated by the electromagnetic brake from interfering with the high-resolution position sensor.

In one aspect, the gearbox comprises a worm gear coupled to the driven shaft and configured to rotate therewith, the worm gear configured to turn a worm wheel, the worm wheel configured to move the extensible member.

In one aspect, the extensible member comprises a leadscrew configured to move axially in response to rotation of a lead nut; wherein the worm wheel is coupled to rotate the lead nut.

In one aspect, the gearbox comprises a torque tube mounted on a bearing for rotation about a tube axis; wherein the lead nut is disposed within a bore of the torque tube and fixed to rotate therewith; and wherein the worm wheel is disposed about an outer surface of the torque tube and fixed thereto.

In one aspect, the extensible member comprises a gear rack configured to move axially in response to rotation of a gear in meshing engagement therewith.

In one aspect, the actuator includes a cover attached to the gearbox and configured to enclose the extensible member.

In one aspect, the actuator includes a flexible boot configured to enclose the extensible member and to extend with the extensible member as the extensible member moves linearly.

In one aspect, the actuator includes a flex coupling operatively disposed between the electric motor and a gearbox input shaft and configured to provide a degree of relative rotation therebetween.

In one aspect, the flex coupling comprises a flex shaft extending between a first end fixed to a motor shaft and a second end fixed to the gearbox input shaft, the flex shaft of the flex coupling configured to twist for allowing relative rotation between the first end and the second end.

In one aspect, the flex coupling comprises a resilient material configured to deform to provide the degree of relative rotation.

In one aspect, the actuator includes a controller configured to control the powered actuator and to provide a haptic feedback by the powered actuator.

In one aspect, the high-resolution position sensor is configured to output a predetermined number of Hall counts per motor revolution.

In another aspect, a powered actuator for a closure of a vehicle includes: an electric motor configured to rotate a driven shaft; an extensible member configured to be coupled to one of a body or the closure of the vehicle for opening or closing the closure; a gearbox configured apply a force to the extensible member for causing the extensible member to move linearly in response to rotation of the driven shaft; and an adapter configured to mount the gearbox to a shut face of the closure.

In one aspect, the adapter is configured to mount to a preexisting mounting point on the shut face of the closure, the preexisting mounting point configured to hold a door check device for limiting rotational travel of the closure.

In one aspect, the adapter is configured to provide a rotational degree of freedom between the gearbox and the shut face of the closure for accommodating installation in a door cavity.

In one aspect, the adapter comprises a door adapter bracket, and the extensible member is configured to attached to the body or closure without a linkage, wherein the motor and gearbox are disposed adjacent the shut face to reduce a loading moment on the shut face caused by weight of the actuator.

In one aspect, the actuator includes a high-resolution position sensor coupled to the driven shaft and configured to detect a position of the driven shaft.

In another aspect, a powered actuator for a closure of a vehicle includes: an electric motor configured to rotate a driven shaft; an extensible member configured to be coupled to one of a body or the closure of the vehicle for opening or closing the closure; a gearbox configured apply a force to the extensible member for causing the extensible member to move linearly in response to rotation of the driven shaft; and a scraper assembly attached to the extensible member and configured to remove debris from the extensible member as the extensible member translates linearly.

In one aspect, the gearbox includes a lead nut rotatable in response to rotation by the driven shaft, wherein the scraper assembly is driven by the lead nut.

In one aspect, the scraper assembly includes a housing, a scraper tooth attached to the housing, and a scraper seal disposed inside the housing, wherein the scraper seal rotates with the scraper housing.

In one aspect, the actuator includes a cover attached to a housing of the powered actuator in a sealed manner, the cover defining an opening through which the extensible member is extendable axially outward, wherein the scraper assembly is disposed inside of the cover.

In one aspect, the actuator include a high-resolution position sensor coupled to the driven shaft and configured to detect a position of the driven shaft.

In accordance with yet another aspect, there is provided a powered actuator for a closure of a vehicle including an electric motor configured to rotate a driven shaft, an extensible member configured to be coupled to one of a body or the closure of the vehicle for opening or closing the closure, a gearbox including a gearbox housing, the gearbox configured to apply a force to the extensible member for causing the extensible member to move linearly in response to rotation of the driven shaft, and at least one sealing assembly configured to seal the gearbox housing as the extensible member translates linearly.

In accordance with yet another aspect, there is provided a system for controlling movement of a closure of a vehicle, the system including a powered actuator for an electric motor configured to rotate a driven shaft, an extensible member configured to be coupled to one of a body or the closure of the vehicle for opening or closing the closure, a gearbox including a gearbox housing, the gearbox configured to apply a force to the extensible member for causing the extensible member to move linearly in response to rotation of the driven shaft, and a high resolution position sensor configured for detecting rotation of the driven shaft. The system further includes a servo controller in electrical communication with the electric motor and the high resolution position sensor to control the electric motor based on at least detection of the position of the shaft in response to receiving a position signal from the high resolution position sensor. The system may further include an electromagnetic brake in electrical communication with the servo controller.

In accordance with yet another aspect, there is provided a powered actuator for a closure of a vehicle including an electric motor configured to rotate a driven shaft, an leadscrew configured to be coupled to one of a body or the closure of the vehicle for opening or closing the closure, a gearbox including a gearbox housing, the gearbox configured to apply a force to the leadscrew for causing the extensible member to move linearly in response to rotation of the driven shaft, and at least one sealing assembly configured to seal the gearbox housing as the leadscrew translates linearly into and out of the gearbox housing. The leadscrew may translated linearly out of the gearbox housing such that the threads of the leadscrew are exposed to an exterior environment.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an example motor vehicle equipped with a power closure member actuation system situated between the front passenger swing door and a vehicle body, according to aspects of the disclosure;

FIG. 2 is a perspective inner side view of a closure member shown in FIG. 1, with various components removed for clarity purposes only, in relation to a portion of the vehicle body and which is equipped with the power closure member actuation system, according to aspects of the disclosure;

FIG. 3 illustrates a block diagram of the power closure member actuation system, according to aspects of the disclosure;

FIG. 4 illustrates another block diagram of the power closure member actuation system for moving the closure member in an automatic mode, according to aspects of the disclosure;

FIGS. 5 and 5A illustrates the power closure member actuation system shown as part of a vehicle system architecture, according to aspects of the disclosure;

FIG. 6 illustrates another block diagram of the power closure member actuation system for moving the closure member in a powered assist mode, according to aspects of the disclosure;

FIG. 7 illustrates a first powered actuator according to aspects of the disclosure;

FIG. 8 illustrates a second powered actuator according to aspects of the disclosure;

FIG. 9 illustrates the first powered actuator of FIG. 7, according to aspects of the disclosure;

FIG. 10 illustrates a non-powered door check device;

FIG. 11A illustrates a powered actuator protruding from an internal cavity of a passenger door according to aspects of the disclosure;

FIG. 11B illustrates the powered actuator of FIG. 11A disposed within the internal cavity of the passenger door;

FIG. 12A illustrates the first powered actuator according to aspects of the disclosure;

FIG. 12B illustrates an exploded view of components within the first powered actuator according to aspects of the disclosure;

FIG. 13A illustrates a partial cut-away view of the first powered actuator according to aspects of the disclosure;

FIG. 13B illustrates cut-away view of an EM brake of the powered actuator according to aspects of the disclosure;

FIG. 14 illustrates a cut-away view of a third powered actuator according to aspects of the disclosure;

FIG. 15 illustrates a cut-away view of a fourth powered actuator according to aspects of the disclosure;

FIG. 16A illustrates an exploded perspective view of a motor and coupling of a fifth powered actuator according to aspects of the disclosure;

FIG. 16B illustrates a perspective view of the motor and a partial drive assembly within the fifth powered actuator according to aspects of the disclosure;

FIG. 16C illustrates a slip device of the coupling of the fifth powered actuator according to aspects of the disclosure;

FIG. 17 illustrates a perspective view of a motor and a partial drive assembly within a sixth powered actuator according to aspects of the disclosure;

FIG. 18 illustrates a cut-away perspective view of a motor and a partial drive assembly within a seventh powered actuator according to aspects of the disclosure;

FIG. 19 illustrates a cut-away perspective view of an eighth powered actuator according to aspects of the disclosure;

FIG. 20 illustrates a schematic diagram of components within a powered actuator in a first configuration according to aspects of the disclosure;

FIG. 21 illustrates a schematic diagram of components within a powered actuator in a second configuration according to aspects of the disclosure;

FIG. 22 illustrates a schematic diagram of components within a powered actuator in a third configuration according to aspects of the disclosure;

FIG. 23 illustrates a schematic diagram of components within a powered actuator in a fourth configuration according to aspects of the disclosure;

FIG. 24 illustrates a perspective view of a ninth powered actuator according to aspects of the disclosure;

FIG. 25A illustrates a perspective view of the ninth powered actuator with a telescoping boot in an expanded state according to aspects of the disclosure;

FIG. 25B illustrates a perspective view of the ninth powered actuator with the telescoping boot in a compressed, or retracted, state, according to aspects of the disclosure;

FIG. 26 illustrates a schematic diagram of components within a powered actuator of the prior art;

FIG. 27 illustrates a schematic diagram of components within a powered actuator according to aspects of the disclosure;

FIG. 28 illustrates an exploded perspective view of a scraper assembly and sealing arrangement for use with a powered actuator according to aspects of the disclosure;

FIG. 29 is a partial perspective view showing the scraper assembly in an assembled configuration with the gearbox housing, according to aspects of the disclosure;

FIG. 30 is a close up partial view of the scraper assembly of FIG. 28 illustrative the grooved inner surface of the scraper seal member for mating in a sealing and/or scrapping engagement with the leadscrew, according to aspects of the disclosure;

FIG. 31 is cut-away perspective view the showing the scraper in an assembled configuration with the gearbox housing and the scraper seal member in a sealing and/or scrapping engagement with the leadscrew, according to aspects of the disclosure; and

FIG. 32 is a perspective via of a coupling between the scraper assembly and a nut of the powered actuator, according to aspects of the disclosure.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

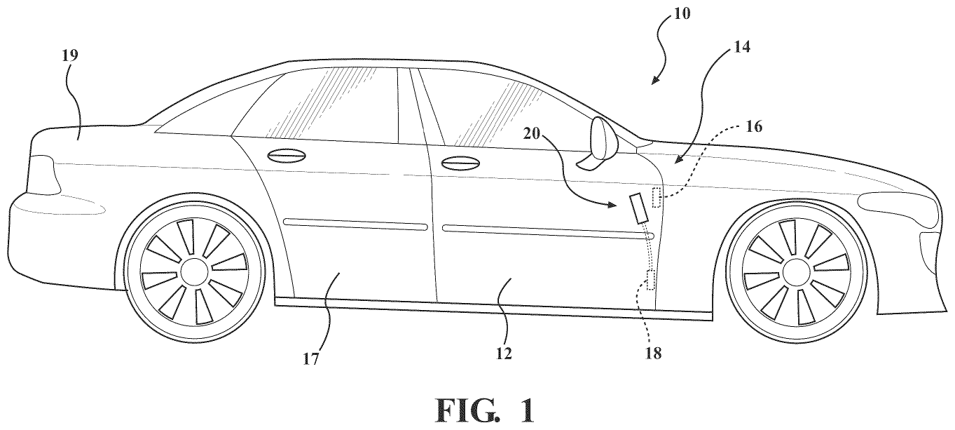

Referring initially to FIG. 1, an example motor vehicle 10 is shown to include a first passenger door 12 pivotally mounted to a vehicle body 14 via an upper door hinge 16 and a lower door hinge 18 which are shown in phantom lines. In accordance with the present disclosure, a power closure member actuation system 20 is integrated into the pivotal connection between first passenger door 12 and a vehicle body 14. In accordance with a preferred configuration, power closure member actuation system 20 generally includes a power-operated actuator mechanism or actuator 22 secured within an internal cavity of passenger door 12, and a rotary drive mechanism that is driven by the power-operated actuator mechanism 22 and is drivingly coupled to a hinge component associated with lower door hinge 18. Driven rotation of the rotary drive mechanism causes controlled pivotal movement of passenger door 12 relative to vehicle body 14. In accordance with this preferred configuration, the power-operated actuator mechanism 22 is rigidly coupled in close proximity to a door-mounted hinge component of upper door hinge 16 while the rotary drive mechanism is coupled to a vehicle-mounted hinge component of lower door hinge 18. However, those skilled in the art will recognize that alternative packaging configurations for power closure member actuation system 20 are available to accommodate available packaging space. One such alternative packaging configuration may include mounting the power-operated actuator mechanism to vehicle body 14 and drivingly interconnecting the rotary drive mechanism to a door-mounted hinge component associated with one of upper door hinge 16 and lower door hinge 18.

Each of upper door hinge 16 and lower door hinge 18 include a door-mounting hinge component and a body-mounted hinge component that are pivotably interconnected by a hinge pin or post. The door-mounted hinge component is hereinafter referred to a door hinge strap while the body-mounted hinge component is hereinafter referred to as a body hinge strap. While power closure member actuation system 20 is only shown in association with front passenger door 12, those skilled in the art will recognize that the power closure member actuation system can also be associated with any other closure member (e.g., door or liftgate) of vehicle 10 such as rear passenger doors 17 and decklid 19.

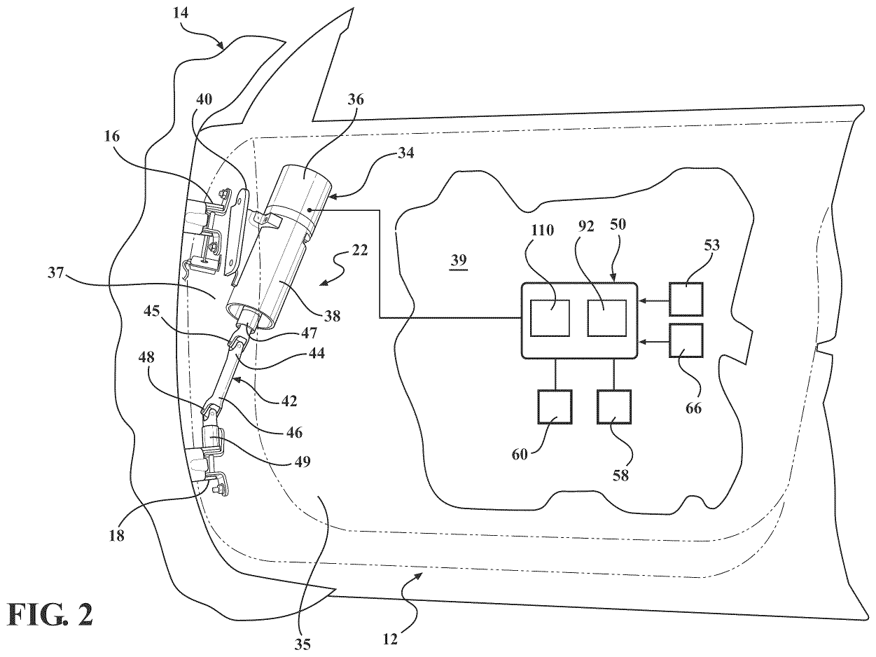

Power closure member actuation system 20 is generally shown in FIG. 2 and, as mentioned, is operable for controllably pivoting vehicle door 12 relative to vehicle body 14 between an open position and a closed position. Lower hinge 18 of power closure member actuation system 20 includes a door hinge strap connected to vehicle door 12 and a body hinge strap connected to vehicle body 14. Door hinge strap and body hinge strap of lower door hinge 18 are interconnected along a generally vertically-aligned pivot axis via a hinge pin to establish the pivotable interconnection between door hinge strap and body hinge strap. However, any other mechanism or device can be used to establish the pivotable interconnection between door hinge strap and body hinge strap without departing from the scope of the subject disclosure.

As best shown in FIG. 2, power closure member actuation system 20 includes a power-operated actuator mechanism 22 having a motor and geartrain assembly 34 that is rigidly connectable to vehicle door 12. Motor and geartrain assembly 34 is configured to generate a rotational force. In the preferred embodiment, motor and geartrain assembly 34 includes an electric motor 36 that is operatively coupled to a speed reducing/torque multiplying assembly, such as a high gear ratio planetary gearbox 38. The high gear ratio planetary gearbox 38 may include multiple stages, thus allowing motor and geartrain assembly 34 to generate a rotational force having a high torque output by way of a very low rotational speed of electric motor 36. However, any other arrangement of motor and geartrain assembly 34 can be used to establish the required rotational force without departing from the scope of the subject disclosure.

Motor and geartrain assembly 34 includes a mounting bracket 40 for establishing the connectable relationship with vehicle door 12. Mounting bracket 40 is configured to be connectable to vehicle door 12 adjacent to the door-mounted door hinge strap associated with upper door hinge 16. As further shown in FIG. 2, this mounting of motor assembly 34 adjacent to upper door hinge 16 of vehicle door 12 disposes the power-operated actuator mechanism 22 of power closure member actuation system 20 in close proximity to the pivot axis of the door 12. The mounting of motor and geartrain assembly 34 adjacent to upper door hinge 16 of vehicle door 12 minimizes the effect that power closure member actuation system 20 may have on a mass moment of inertia (i.e., pivot axis) of vehicle door 12, thus improving or easing movement of vehicle door 12 between its open and closed positions. In addition, as also shown in FIG. 2, the mounting of motor and geartrain assembly 34 adjacent to upper door hinge 16 of vehicle door 12 allows power closure member actuation system 20 to be packaged in front of an A-pillar glass run channel 35 associated with vehicle door 12 and thus avoids any interference with a glass window function of vehicle door 12. Put another way, power closure member actuation system 20 can be packaged in a portion 37 of an internal door cavity 39 within vehicle door 12 that is not being used, and therefore reduces or eliminates impingement on existing hardware/mechanisms within vehicle door 12. Although power closure member actuation system 20 is illustrated as being mounted adjacent to upper door hinge 16 of vehicle door 12, power closure member actuation system 20 can, as an alternative, also be mounted elsewhere within vehicle door 12 or even on vehicle body 14 without departing from the scope of the subject disclosure.

Power closure member actuation system 20 further includes a rotary drive mechanism that is rotatively driven by the power-operated actuator mechanism 22. As shown in FIG. 2, the rotary drive mechanism includes a drive shaft 42 interconnected to an output member of gearbox 38 of motor and geartrain assembly 34 and which extends from a first end 44 disposed adjacent gearbox 38 to a second end 46. The rotary output component of motor and geartrain assembly 34 can include a first adapter 47, such as a square female socket or the like, for drivingly interconnecting first end 44 of drive shaft 42 directly to the rotary output of gearbox 38 In addition, although not expressly shown, a disconnect clutch can be disposed between the rotary output of gearbox 38 and first end 44 of drive shaft 42. In one configuration, the clutch would normally be engaged without power (i.e., power-off engagement) and could be selectively energized (i.e., power-on release) to disengage. Put another way, the optional clutch drivingly would couple drive shaft 42 to motor and geartrain assembly 34 without the application of electrical power while the clutch would require the application of electrical power to uncouple drive shaft 42 from driven connection with gearbox 38. As an alternative, the clutch could be configured in a power-on engagement and power-off release arrangement. The clutch may engage and disengage using any suitable type of clutching mechanism such as, for example, a set of sprags, rollers, a wrap-spring, friction plates, or any other suitable mechanism. The clutch is provided to permit door 12 to be manually moved by the user between its open and closed positions relative to vehicle body 14. Such a disconnect clutch could, for example, be located between the output of electric motor 36 and the input to gearbox 38. The location of this optional clutch may be dependent based on, among other things, whether or not gearbox 38 includes “back-drivable” gearing.

Second end 46 of drive shaft 42 is coupled to body hinge strap of lower door hinge 18 for directly transferring the rotational force from motor and geartrain assembly 34 to door 12 via body hinge strap. To accommodate angular motion due to swinging movement of door 12 relative to vehicle body 14, the rotary drive mechanism further includes a first universal joint or U-joint 45 disposed between first adapter 47 and first end 44 of drive shaft 42 and a second universal joint or U-joint 48 disposed between a second adapter 49 and second end 46 of drive shaft 42. Alternatively, constant velocity joints could be used in place of the U-joints 45, 48. The second adapter 49 may also be a square female socket or the like configured for rigid attachment to body hinge strap of lower door hinge 18. However, other means of establishing the drive attachment can be used without departing from the scope of the disclosure. Rotation of drive shaft 42 via operation of motor and geartrain assembly 34 functions to actuate lower door hinge 18 by rotating body hinge strap about its pivot axis to which drive shaft 42 is attached and relative to door hinge strap. As a result, power closure member actuation system 20 is able to effectuate movement of vehicle door 12 between its open and closed positions by “directly” transferring a rotational force directly to body hinge strap of lower door hinge 18. With motor and geartrain assembly 34 connected to vehicle door 12 adjacent to upper door hinge 16, second end 46 of drive shaft 42 is attached to body hinge strap of lower door hinge 18. Based on available space within door cavity 39, it may be possible to mount motor and geartrain assembly 34 adjacent to the door-mounted hinge component of lower door hinge 18 and directly connect second end 46 of drive shaft 42 to the vehicle-mounted hinge component of upper door hinge 16. In the alternative, if motor and geartrain assembly 34 is connected to vehicle body 14, second end 46 of drive shaft 42 would be attached to door hinge strap.

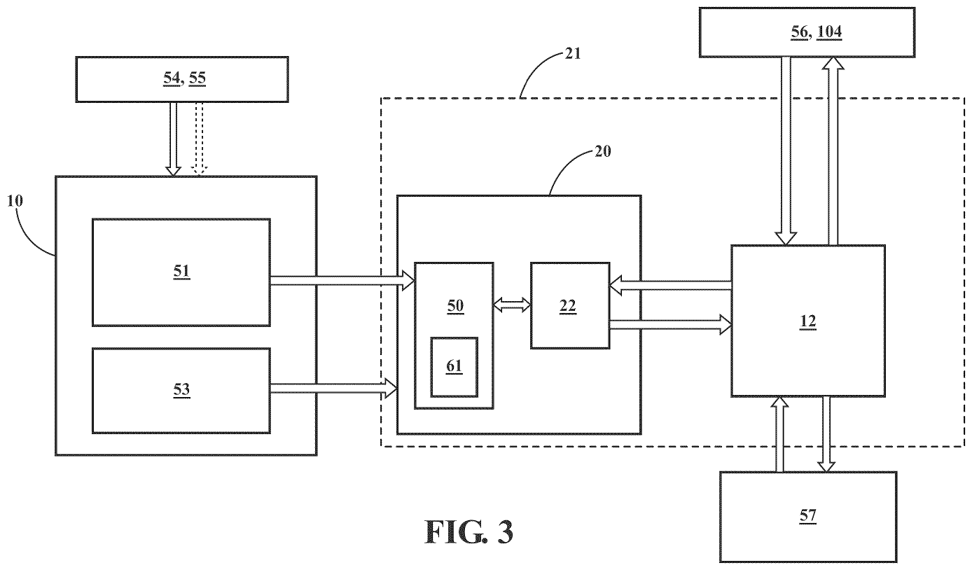

FIG. 3 illustrates a block diagram of the power closure member actuation system 20 of a power door system 21 for moving the closure member (e.g., vehicle door 12) of the vehicle 10 between open and closed positions relative to the vehicle body 14. As discussed above, the power closure member actuation system 20 includes the actuator 22 that is coupled to the closure member (e.g., vehicle door 12) and the vehicle body 14. The actuator 22 is configured to move the closure member 12 relative to the vehicle body 14. The power closure member actuation system 20 also includes a controller 50 that is coupled to the actuator 22 and in communication with other vehicle systems (e.g., a door node control module 52 or a body control module (BCM)) and also receives vehicle power from the vehicle 10 (e.g., from a vehicle battery 53).

The controller 50 is operable in at least one of an automatic mode (in response to an automatic mode initiation input 54) and a powered assist mode (in response to a motion input 56). In the automatic mode, the controller 50 commands movement of the closure member through a predetermined motion profile (e.g., to open the closure member). The powered assist mode is different than the automatic mode in that the motion input 56 from the user 75 may be continuous to move the closure member, as opposed to a singular input by the user 75 in automatic mode. Controller 50 may therefore be configured as a servo controller which may for example receive electrical signals indicative of the position of the door from the closure member actuation system 20, such as a high position count sensor as will be described in more details herein below as an illustrative example, and in response send electrical signals to the actuator 22 based on the received high position count signals to move the door closure member 12. No separate button or switch activations by a user are needed to move the closure member 12, the user only requires to directly move the closure panel 12. Commands 51 from the vehicle systems may, for example, include instructions the controller 50 to open the closure member, close the closure member, or stop motion of the closure member. Such control inputs, such as inputs 54, 56 may also include other types of inputs 55, such as an input from a body control module, which may receive a wireless command to control the door opening based on a signal such as a wireless signal received from the key fob 60, or other wireless device such as a cellular smart phone, or from a sensor assembly provided on the vehicle, such as a radar or optical sensor assembly detecting an approach of a user, such as a gesture or gait e.g. walk of the user 75 upon approach of the user 75 to the vehicle. Also shown are other components that may have an impact on the operation of the power closure member actuation system 20, such as door seals 57 of the vehicle door 12, for example. In addition, environmental conditions 59 (rain, cold, heat, etc.) may be monitored by the vehicle 10 (e.g., by the body control module 52) and/or the controller 50. The controller 50 also includes an artificial intelligence learning algorithm 61 (e.g., series of nodes forming a neural network model shown in FIG. 54), discussed in more detail below.

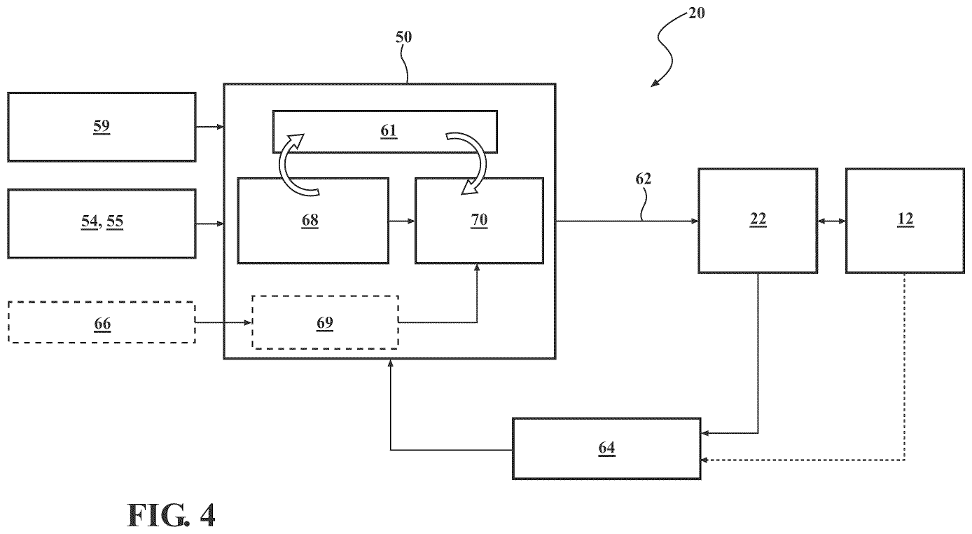

Referring now to FIG. 4, the controller 50 is configured to receive the automatic mode initiation input 54 and enter the automatic mode to output a motion command 62 in response to receiving the automatic mode initiation input 54 or input motion command 62. The automatic mode initiation input 54 can be a manual input on the closure member itself or an indirect input to the vehicle (e.g., closure member switch 58 on the closure member, switch on a key fob 60, etc.). So, the automatic mode initiation input 54 may, for example, be a result of a user or operator operating a switch (e.g., the closure member switch 58), making a gesture near the vehicle 10, or possessing a key fob 60 near the vehicle 10, for example. It should also be appreciated that other automatic mode initiation inputs 54 are contemplated, such as, but not limited to a proximity of the user 75 detected by a proximity sensor.

In addition, the power closure member actuation system 20 includes at least one closure member feedback sensor 64 for determining at least one of a position and a speed and an attitude of the closure member. Thus, the at least one closure member feedback sensor 64 detects signals from either the actuator 22 by counting revolutions of the electric motor 36, absolute position of an extensible member (not shown), or from the door 12 (e.g., an absolute position sensor on a door check as an example) can provide position information to the controller 50. Feedback sensor 64 in communication with controller 50 is illustrative of part of a feedback system or motion sensing system for detecting motion of the door directly or indirectly, such as by detecting changes in speed and position of the closure member, or components coupled thereto. For example, the motion sensing system may be hardware based (e.g. a hall sensor unit an related circuitry) for detecting movement of a target on the closure member (e.g. on the hinge) or actuator 22 (e.g. on a motor shaft) as examples, and/or may also be software based (e.g. using code and logic for executing a ripple counting algorithm) executed by the controller 50 for example. Other types of position, speed, and/or orientation detectors such as accelerometers and induction based sensors may be employed without limitation.

The power closure member actuation system 20 additionally includes at least one non-contact obstacle detection sensor 66 which may form part of a non-contact obstacle detection system coupled, such as electrically coupled, to the controller 50. The controller 50 is configured to determine whether an obstacle is detected using the at least one non-contact obstacle detection sensor 66 (e.g., using a non-contact obstacle detection algorithm 69) and may, for example, cease movement of the closure member in response to determining that the obstacle is detected. The non-contact obstacle detection system may also be configured to calculate distance from the closure member to the object or obstacle, or to a user as the object or obstacle, to the door 12. For example non-contact obstacle detection system may be configured to perform time of flight calculations to determine distance using a radar based sensor 66 or to characterize the object as a user or human as compared to an non-human object for example based on determining the reflectivity of the object using a radar based sensor 66 and system. The non-contact obstacle detection system may also be configured determine when an obstacle is detected, for example by detecting reflected waves of the object or obstacle or user of radar transmitted from the obstacle sensor 66. The non-contact obstacle detection system may also be configured determine when an obstacle is not detected, for example by not detecting reflected waves of the object or obstacle or user of radar transmitted from the obstacle sensor 66. The operation and example of the at least one non-contact obstacle detection sensor 66 and system are discussed in U.S. Patent Application No. 2018/0238099, incorporated herein by reference.

In the automatic mode, the controller 50 can include one or more closure member motion profiles 68 that are utilized by the controller 50 when generating the motion command 62 (e.g., using a motion command generator 70 of the controller 50) in view of the obstacle detection by the at least one non-contact obstacle detection sensor 66. So, in the automatic mode, the motion command 62 has a specified motion profile 68 (e.g., acceleration curve, velocity curve, deceleration curve, and finally stops at an open position) and is continually optimized per user feedback (e.g., automatic mode initiation input 54).

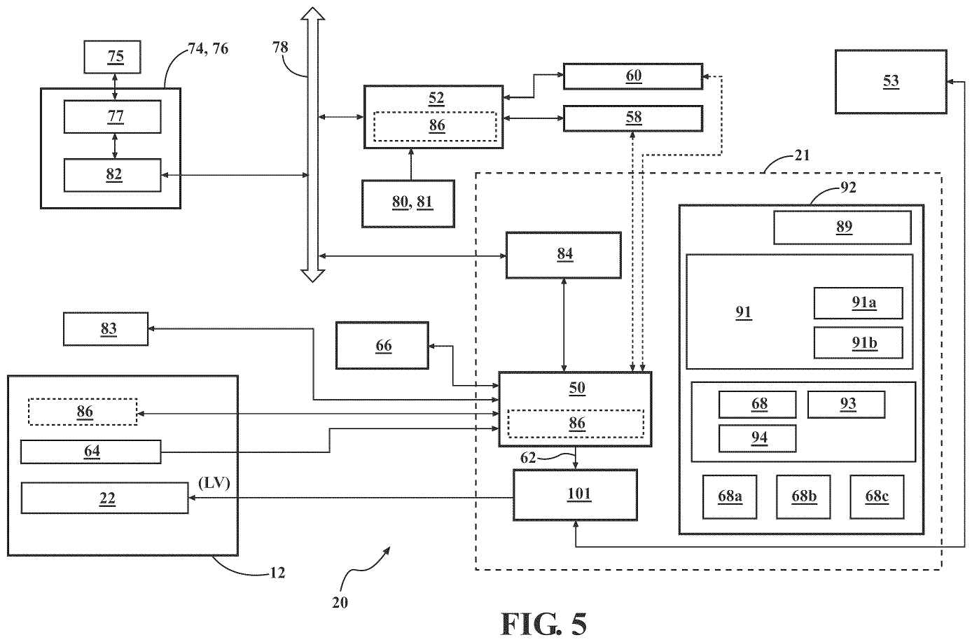

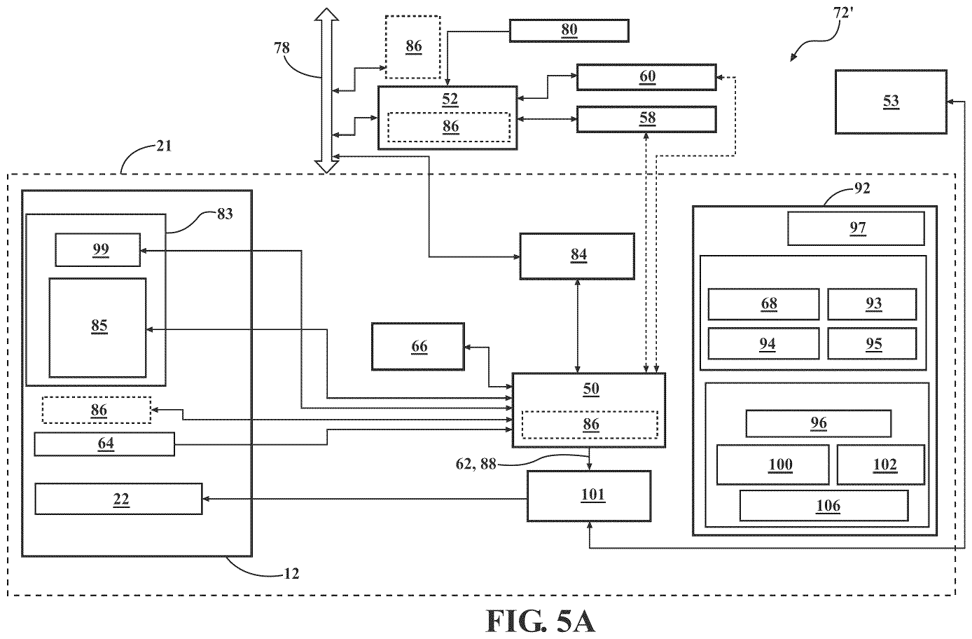

In FIG. 5, the power closure member actuation system 20 is shown as part of a vehicle system architecture 72 corresponding to operation in the automatic mode. The power closure member actuation system 20 includes a user interface 74, 76 that is configured to detect a user interface input from a user 75 via an interface 77 (e.g., touchscreen) to modify at least one stored motion control parameter associated with the movement of the closure member. Thus, the controller 50 of the power closure member actuation system 20 or user modifiable system is configured to present the at least one stored motion control parameter on the user interface 74, 76.

The body control module 52 is in communication with the controller 50 via a vehicle bus 78 (e.g., a Local Interconnect Network or LIN bus). The body control module 52 can also be in communication with the key fob 60 (e.g., wirelessly) and a closure member switch 58 configured to output a closure member trigger signal through the body control module 52. Alternatively, the closure member switch 58 could be connected directly to the controller 50 or otherwise communicated to the controller 50. The body control module 52 may also be in communication with an environmental sensor (e.g., temperature sensor 80). The controller 50 is also configured to modify the at least one stored motion control parameter in response to detecting the user interface input. A screen communications interface control unit 82 associated with the user interface 74, 76 can, for example, communicate with a closure communications interface control unit 84 associated with the controller 50 via the vehicle bus 78. In other words, the closure communication interface control unit 84 is coupled to the vehicle bus 78 and to the controller 50 to facilitate communication between the controller 50 and the vehicle bus 78. Thus, the user interface input can be communicated from the user interface 74, 76 to the controller 50.

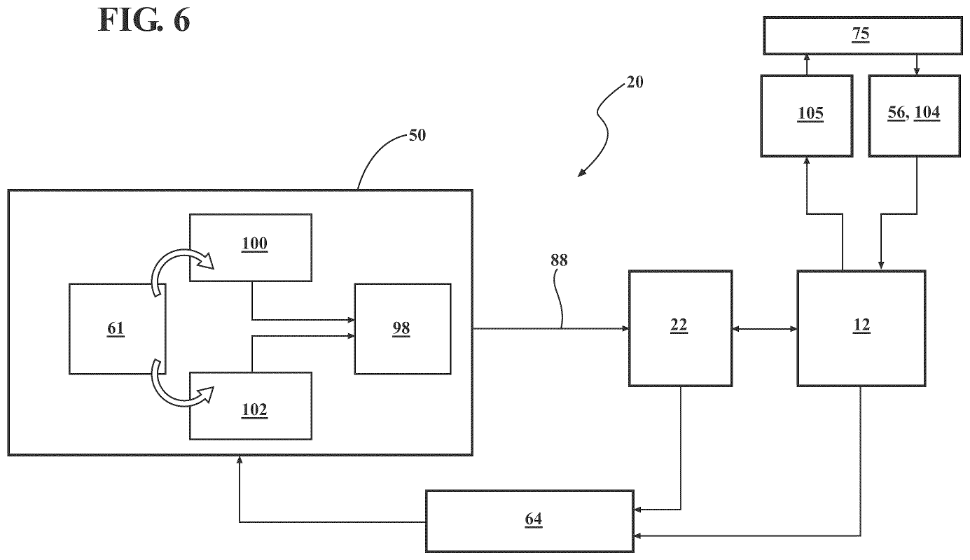

A vehicle inclination sensor 86 (such as an accelerometer) is also coupled to the controller 50 for detecting an inclination of the vehicle 10. The vehicle inclination sensor 86 outputs an inclination signal corresponding to the inclination of the vehicle 10 and the controller 50 is further configured to receive the inclination signal and adjust the one of a force command 88 (FIG. 6) and the motion command 62 accordingly. While the vehicle inclination sensor 86 may be separate from the controller 50, it should be understood that the vehicle inclination sensor 86 may also be integrated in the controller 50 or in another control module, such as, but not limited to the body control module 52.

The controller 50 is further configured to perform at least one of an initial boundary condition check prior to the generation of the command signal (e.g., the force command 88 or the motion command 62) and an in-process boundary check during the generation of the command signal. Such boundary checks prevent movement of the closure member and operation of the actuator 22 outside a plurality of predetermined operating limits or boundary conditions 91 and will be discussed in more detail below.

The controller 50 can also be coupled to a vehicle latch 83. In addition, the controller 50 is coupled to a memory device 92 having at least one memory location for storing at least one stored motion control parameter associated with controlling the movement of the closure member (e.g., door 12). The memory device 92 can also store one or more closure member motion profiles 68 (e.g., movement profile A 68a, movement profile B 68b, movement profile C 68c) and boundary conditions 91 (e.g., the plurality of predetermined operating limits such as minimum limits 91a, and maximum limits 91b). The memory device 92 also stores original equipment manufacturer (OEM) modifiable door motion parameters 89 (e.g., door check profiles and pop-out profiles).

The controller 50 is configured to generate the motion command 62 using the at least one stored motion control parameter to control an actuator output force acting on the closure member to move the closure member. A pulse width modulation unit 101 is coupled to the controller 50 and is configured to receive a pulse width control signal and output an actuator command signal corresponding to the pulse width control signal.

Similar to FIG. 5, FIG. 5A shows the power closure member actuation system 20 as part of another vehicle system architecture 72′ operable in the automatic mode and the powered assist mode. The body control module 52 may also be in communication with at least one environmental sensor 80, 81 for sensing at least one environmental condition 59. Specifically, the at least one environmental sensor 80, 81 can be at least one of a temperature sensor 80 or a rain sensor 81. While the temperature sensor 80 and rain sensor 81 may be connected to the body control module 52, they may alternatively be integrated in the body control module 52 and/or integrated in another unit such as, but not limited to the controller 50. In addition, other environmental sensors 80, 81 are contemplated.

The controller is also coupled with the latch 83 that includes a cinch motor 99 (for cinching the closure member 12 into the closed position). The latch 83 also includes a plurality of primary and secondary ratchet position sensors or switches 85 that provide feedback to the controller 50 regarding whether the latch 83 is in a latch primary position or a latch secondary position, for example.

Again, the vehicle inclination sensor 86 (such as an accelerometer or inclinometer) is also coupled to the controller 50 for detecting the inclination of the vehicle 10. The vehicle inclination sensor 86 outputs an inclination signal corresponding to the inclination of the vehicle 10 and the controller 50 is further configured to receive the inclination signal and adjust the one of the force command 88 (FIG. 6) and the motion command 62 accordingly. Accordingly may be for example adjusting the motion command 62 such that door 12 moves at the same speed and motion profile as compared to the door 12 being moved by a motion command as if on a level terrain. As a result, the actuator 22 may move the door 12 such that the motion profile (e.g. speed versus door position) when on an incline is the same as or is tracking to the motion profile as if the vehicle was not on an incline. In other words the user detects no visual difference in the door motion appearance of speed versus position as when the vehicle 10 is on an incline or not. Or for example accordingly may be adjusting the force command 88 such that door 12 is moved applying the similar resistance force detected by a user as compared to the door being moved by a force command as if on level terrain. As a result, the actuator 22 may move the door such that the force required to move the door 12 by a user when on an incline is the same as the force required by a user to move the door as if the vehicle was not on an incline. In other words, the user experiences the same reactionary resistive force of the door acting against the input force of the user when the vehicle 10 is on an incline or not.

A pulse width modulation unit 101 is also coupled to the controller 50 and is configured to receive a pulse width control signal and output an actuator command signal corresponding to the pulse width control signal. The controller 50 includes a processor or other computing unit 110 in communication with the memory device 92. So, the controller 50 is coupled to the memory device 92 for storing a plurality of automatic closure member motion parameters 68, 93, 94, 95 for the automatic mode and a plurality of powered closure member motion parameters 96, 100, 102, 106 for the powered assist mode and used by the controller 50 for controlling the movement of the closure member (e.g., door 12 or 17). Specifically, the plurality of automatic closure member motion parameters 68, 93, 94, 95 includes at least one of closure member motion profiles 68 (e.g., plurality of closure member velocity and acceleration profiles), a plurality of closure member stop positions 93 (e.g., see FIG. 46), a closure member check sensitivity 94, and a plurality of closure member check profiles 95. The plurality of powered closure member motion parameters 96, 100, 102, 106 includes at least one of a plurality of fixed closure member model parameters 96 and a force command generator algorithm 100 and a closure member model 102 and a plurality of closure member component profiles 106. In addition, the memory device 92 stores a date and mileage and cycle count 97. The memory device 92 may also store boundary conditions (e.g., plurality of predetermined operating limits) used for a boundary check to prevent movement of the closure member and operation of the actuator 22 outside a plurality of predetermined operating limits or boundary conditions.

Consequently, the controller 50 is configured to receive one of the motion input 56 associated with the powered assist mode and the automatic mode initiation input 54 associated with the automatic mode. The controller 50 is then configured to send the actuator 22 one of a motion command 62 based on the plurality of automatic closure member motion parameters 68, 93, 94, 95 in the automatic mode and the force command 88 based on the plurality of powered closure member motion parameters 96, 100, 102, 106 in the powered assist mode to vary the actuator output force acting on the closure member 12 to move the closure member 12. The controller 50 additionally monitors and analyzes historical operation of the power closure member actuation system 20 using the artificial intelligence learning algorithm 61 and adjusts the plurality of automatic closure member motion parameters 68, 93, 94, 95 and the plurality of powered closure member motion parameters 96, 100, 102, 106 accordingly.

As discussed above, the power closure member actuation system 20 can include an environmental sensor 80, 81 in communication with the controller 50 and configured to sense at least one environmental condition of the vehicle 10. Thus, the historical operation monitored and analyzed by the controller 50 using the artificial intelligence learning algorithm 61 can include the at least one environmental condition of the vehicle 10. So, the controller is further configured to adjust the plurality of automatic closure member motion parameters 68, 93, 94, 95 and the plurality of powered closure member motion parameters 96, 100, 102, 106 based on the at least one environmental condition of the vehicle 10.

As best shown in FIG. 6, the controller 50 is also configured to receive the motion input 56 and enter the powered assist mode to output the force command 88 (e.g., using a force command generator 98 of the controller 50 as a function of a force command algorithm 100, door model 102, boundary conditions 91, a plurality of closure member component profiles 106 as discussed in more detail below) as modified by the artificial intelligence learning algorithm 61. The controller 50 is also configured to generate the force command 88 to control an actuator output force acting on the closure member to move the closure member. So, the controller 50 varies an actuator output force acting on the closure member to move the closure member in response to receiving the motion input 56. In the powered assist mode, the force command 88 has a specified force profile (e.g., that may be altered to change the user experience with the closure member, such as by making it lighter or heavier, or based on changes in the environmental condition and modified by the artificial intelligence learning algorithm 61, such as by increasing or decreasing the force assist provided to the user 75). The force command 88 is continually optimized per current user feedback, for example. A user movement sensor 104 is coupled to the controller 50 and is configured to sense the motion input 56 from the user 75 on the closure member to move the closure member. Door motion feedback 105 is also provided from the closure member (e.g., door 12) back to the user 75. Again, the power closure member actuation system 20 further includes at least one closure member feedback sensor 64 for determining at least one of a position and speed of the closure member. The at least one closure member feedback sensor 64 detects the position and/or speed of the closure member, as described above for the automatic mode, and can provide corresponding position/motion information or signals to the controller 50 concerning how the user 75 is interacting with the closure member. For example, the at least one closure member feedback sensor 64 determine how fast the user 75 is moving the closure member (e.g., door 12). The attitude or inclination sensor 86 may also determine the angle or inclination of the closure member and the power closure member actuation system 20 may compensate for such an angle to assist the user 75 and negate any effects on the closure member motion that the change in angle causes (e.g., for example changes regarding how gravity may influence the closure member differently based on the angle of the closure member relative to a ground plane).

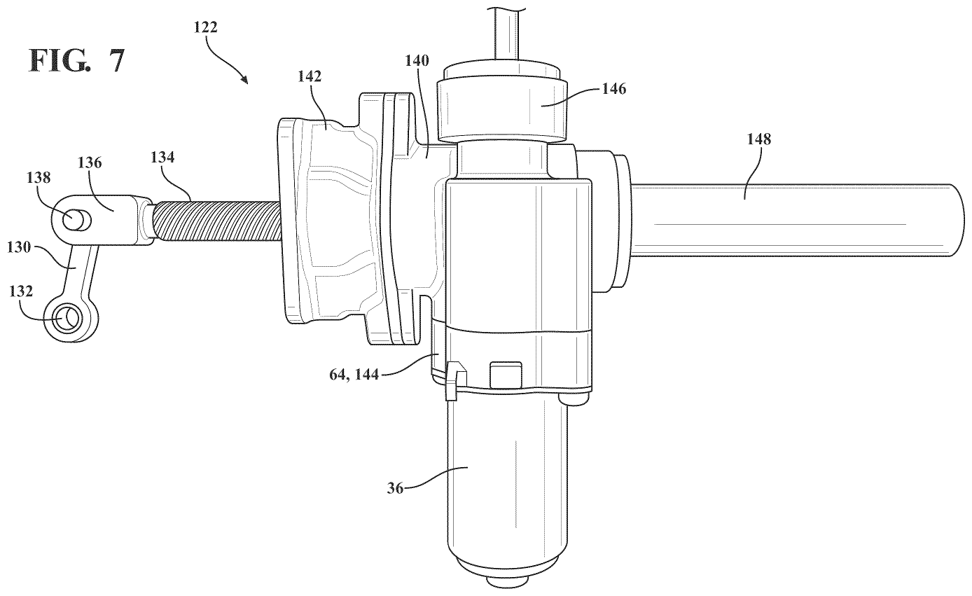

Referring now to FIG. 7, a first powered actuator 122 is disclosed. The first powered actuator 122 includes a link bar 130 defining a distal hole 132. The distal hole 132 is configured to be connected to the vehicle body 14 in some embodiments where the first powered actuator 122 is disposed within the closure, for example as shown in FIG. 2. Alternatively, the distal hole 132 may be configured to be connected to the closure, such as a vehicle side door 12, 17 in embodiments where the first powered actuator is disposed outside of the closure, for example within a structure of the vehicle body 14. The link bar 130 is connected to an extensible member 134 via a linkage 136 having a pin 138 pivotably supporting the link bar 130. Thus, the extensible member 134 is configured to be coupled to the vehicle body 14 or the closure of the vehicle for opening or closing the closure. Linkage 136 may be directly pivotally coupled to vehicle body 14 for example, via the distal hole 132 provided rather on linkage 136 for facilitating connection of the linkage 136 to the vehicle body 14, without a link bar 130.

The first powered actuator 122 also includes a gearbox 140 configured to apply a force to the extensible member 134 for causing the extensible member 134 to move linearly. An adapter 142 is configured to mount the gearbox 140 to the closure or to the vehicle body 14. An electric motor 36 is coupled to the gearbox 140 for driving the first powered actuator 122. The electric motor 36 may be a standard DC motor such as a permanent magnet (e.g. ferrite) or a reluctance type motor. The electric motor 36 may be a brushless DC (BLDC) type motor such as a permanent magnet (e.g. ferrite) or a reluctance type motor. A closure member feedback sensor 64 in the form of a high-resolution position sensor 144 is disposed between the electric motor 36 and the gearbox 140. The high-resolution position sensor 144 may include a magnet wheel and a Hall effect sensor to provide speed, direction, and/or positional information regarding the extensible member 134 and the closure attached thereto. An electromagnetic (EM) brake 146 is coupled to the gearbox 140 on an opposite side from the electric motor 36. The EM brake 146 is optional and may not be included in all powered actuators. A cover 148 is attached to the gearbox 140 and is configured to enclose the extensible member 134. The cover 148 may help to prevent dust or dirt from fouling the extensible member 134 and/or to protect the extensible member 134 from contacting other components within the closure or the vehicle body 14. The cover 148 is formed as a hollow cylindrical tube, as shown on FIG. 7.

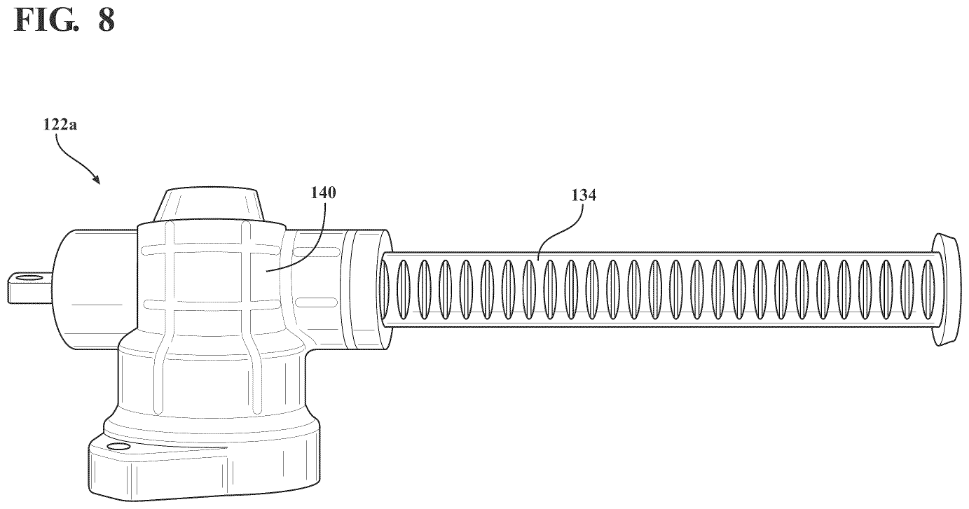

In some embodiments, and as shown in the first powered actuator 122 of FIG. 7, the extensible member 134 includes a leadscrew having one or more helical threads extending thereabout. The extensible member 134 may have other configurations. For example, FIG. 8 shows a second powered actuator 122a in which the extensible member 134 is configured as a rack gear that is configured to be driven linearly by a corresponding gear, such as a pinion gear (not shown) in the gearbox 140. In some embodiments, the gearbox 140 of the second powered actuator 122a may include a planetary gear drive with a rack and pinion output.

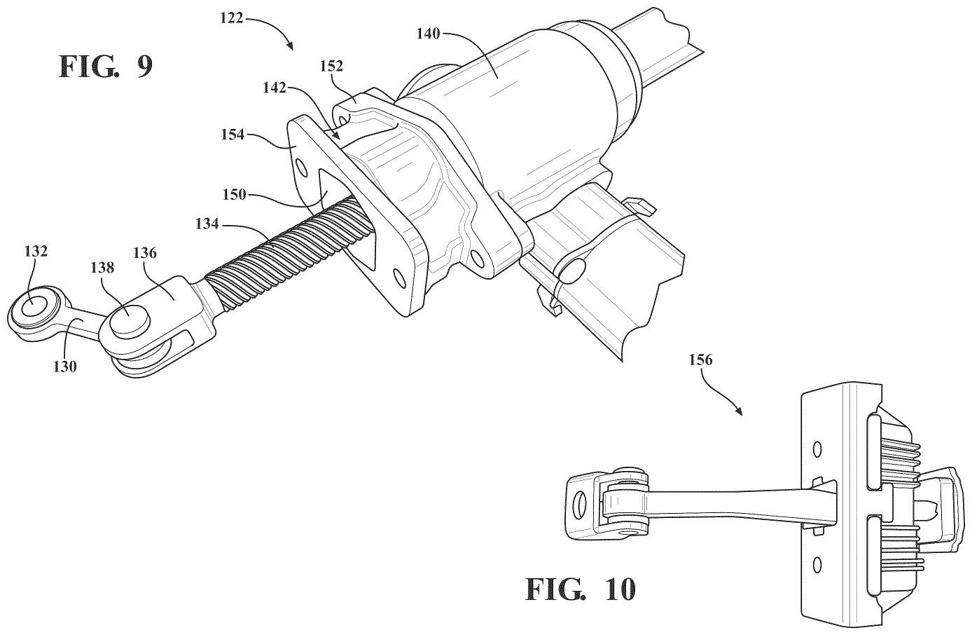

FIG. 9 shows another view of the first powered actuator 122 showing details of the adapter 142. As shown in FIG. 9, the adapter 142 has a generally tubular shape defining a central bore 150 for the extensible member 134 pass through. The adapter 142 includes a first flange 152 that is configured to be fixed to the gearbox 140 using a pair of screws or bolts. The adapter 142 also includes a second flange 154 that is configured to be fixed to the closure. Different adapters 142 having different configurations may be used to adapt powered actuators of the present disclosure to different vehicular applications, such as for different vehicles or for different closures within a same vehicle.

In some embodiments, the adapter 142 is configured to allow the first powered actuator 122 to be a direct replacement for a non-powered door check device 156 for limiting rotational travel of the closure, such as the door check device 156 shown in FIG. 10.

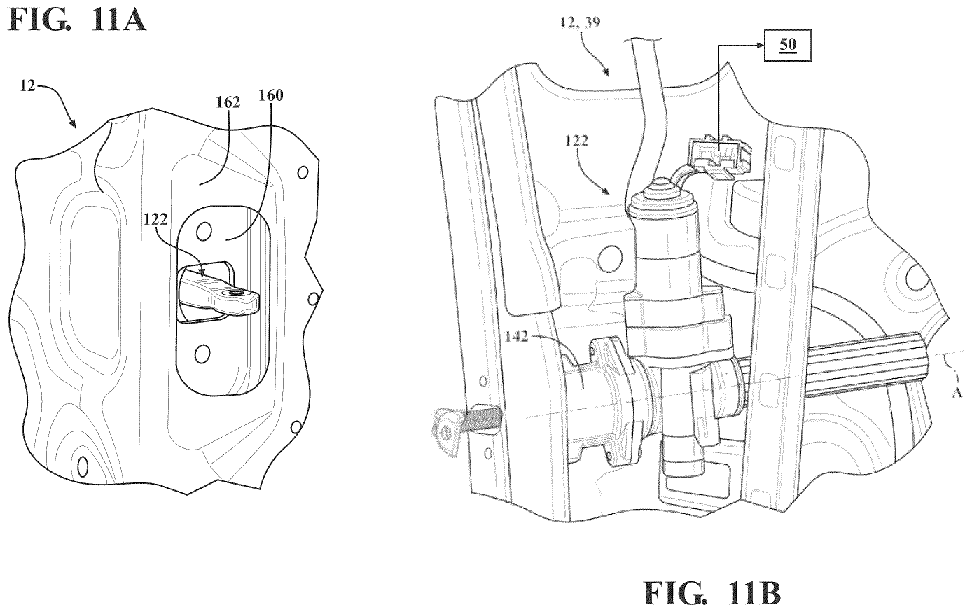

FIG. 11A illustrates the first powered actuator 122 protruding from an internal door cavity 39 of a front passenger door 12 according to aspects of the disclosure. The powered actuator 22, 122 of the present disclosure may be similarly within any vehicle closure, such as any swing door or a swing-type tailgate. Specifically, first powered actuator 122 is configured to mount to a preexisting mounting point 160 on the shut face 162 of the closure 12. The preexisting mounting point 160 is also configured to hold a door stopper, such as door check device 156 shown in FIG. 10.

FIG. 11B illustrates the powered actuator of FIG. 11A disposed within the internal cavity 39 of the passenger door 12. In some embodiments, the adapter 142 is configured to provide a rotational degree of freedom between the gearbox 140 and the shut face 162 of the closure for accommodating installation in a door cavity 39. For example, the powered actuator 122 may be rotated about a central axis A through the extensible member 134 and along which the extensible member 134 translates to open or close the door 12.

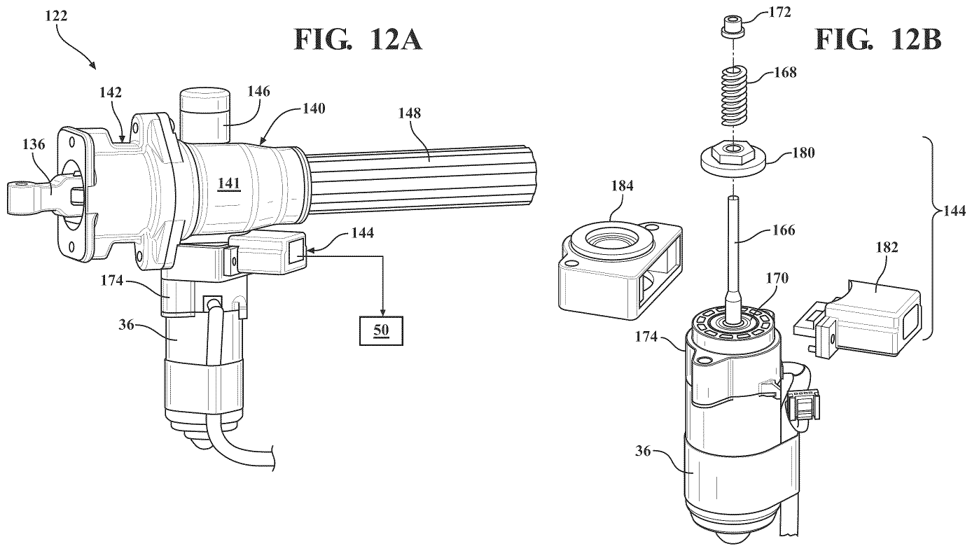

FIGS. 12A-12B illustrate the first powered actuator 122 according to aspects of the disclosure. Specifically, FIG. 12B shows the electric motor 36 configured to rotate a driven shaft 166 for turning a worm gear 168. The driven shaft 166 is supported by a proximal bearing 170 and a distal bearing 172. The proximal bearing 170 is supported within a motor bracket 174 that is attached to an axial end of the electric motor 36. The proximal bearing 170 is shown as a ball bearing and the distal bearing 172 is shown as a plain bearing or a bushing. However, either of the bearings 170, 172 may be a different type of bearing, such as a plain bearing, a ball bearing, a roller bearing, or a needle bearing. FIG. 12B also shows internal components of the high-resolution position sensor 144, including a magnet wheel 180 that is coupled to rotate with the driven shaft 166 and which includes a plurality of permanent magnets. The magnet wheel 180 shown in FIG. 12B has six permanent magnets, but the magnet wheel 180 may include any number of magnets. The high-resolution position sensor 144 also includes a Hall-effect sensor 182 configured to detect a movement of the permanent magnets in the magnet wheel 180 thereby and to generate an electrical signal in response to rotary movement of the magnet wheel 180. The high-resolution position sensor 144 also includes a sensor housing 184 enclosing the magnet wheel 180 and all or part of the Hall-effect sensor 182.

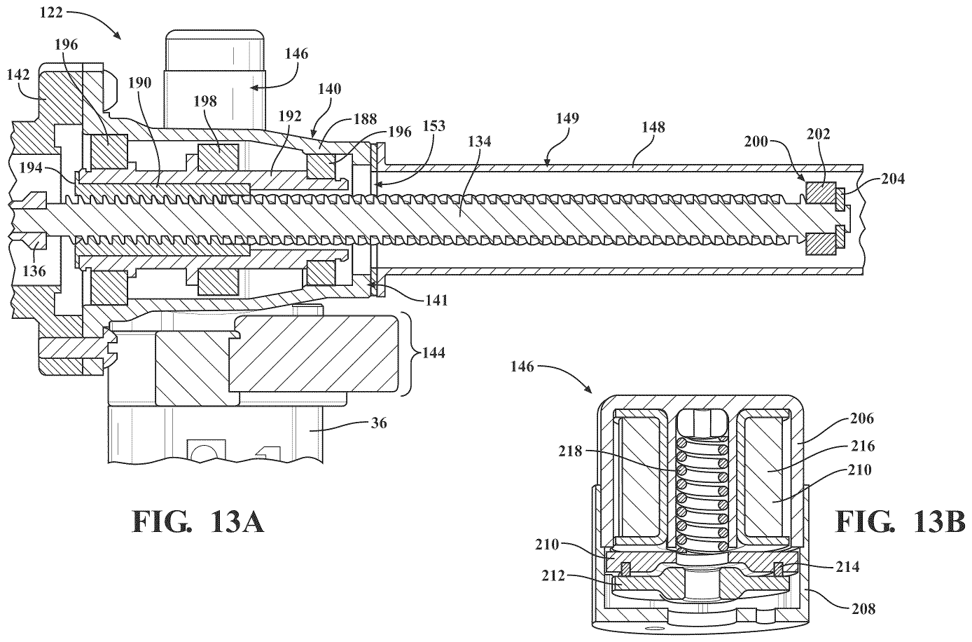

FIG. 13A illustrates a partial cut-away view of the first powered actuator 122 according to aspects of the disclosure. FIG. 13A shows the general arrangement of the gearbox 140, including a gearbox housing 141 extending between the adapter 142 and the cover 148 and between the electric motor 36 and the EM brake 146, with the electric motor 36 and the EM brake 146 being aligned with one another and disposed perpendicular to the extensible member 134.

FIG. 13A also shows the internal details of the gearbox 140, including a lead nut 190 disposed around in threaded engagement with the extensible member 134 that is formed as a leadscrew. The leadscrew and lead nut configuration shown in FIG. 13A may provide a relatively low amount of backlash, thereby improving correlation between the detected position by the high-resolution position sensor 144 and the actual position of the closure. Such high precision detection may improve servo control of the powered actuator 22, 122. For example, the high-resolution sensor 144 signal may be configured to output at least 41 Hall counts per motor revolution for use by the servo control system, for example as shown in the table below illustrating a 5000 minimum Hall count for a 100 mm leadscrew travel:

| | Avg | | | | | Counts/ |
|---|---|---|---|---|---|---|
| Min | Travel | Lead | # of | Counts/ | Gear | Motor |
| Counts | (mm) | (mm) | Turns | turn | Ratio | Rev |
| 5000 | 100 | 18 | 5.56 | 900 | 22 | 41 |

The high-resolution sensor 144 signal may be configured to output other Hall counts per motor revolution for use by the servo control system. For example, the Hall count output may be greater than 2 Hall counts per motor revolution.

The lead nut 190 is fixed within a torque tube 192 having a tubular shape. Specifically the lead nut 190 includes a flanged end 194 that protrudes radially outwardly and engages an axial end of the torque tube 192 at an end of the torque tube 192 adjacent to the adapter 142. The torque tube 192 is held within the gearbox housing 188 by a pair of tube supports 196, with each of the tube supports 196 disposed around the torque tube 192 at or near a corresponding axial end thereof. One or both of the tube supports 196 may include a bearing, such as a ball bearing or a roller bearing. A worm wheel gear 198 is disposed around the torque tube 192 between the tube supports 196 and is fixed to rotate with the torque tube 192. The worm wheel gear 198 is in meshing engagement with the worm gear 168 (shown on FIG. 12B), thus causing the torque tube 192 and the lead nut 190 to be rotated in response to the electric motor 36 driving the worm gear 168.

The first powered actuator 122 shown in FIG. 13A also includes a travel limiter 200 disposed on an axial end of the extensible member 134 opposite (i.e. farthest away from) the linkage 136. The travel limiter 200 is configured to engage a part of the gearbox 140, such as the torque tube 192, for limiting axial extension of the extensible member 134. Specifically, the travel limiter 200 includes a bumper 202 of resilient material, such as rubber, having a tubular shape extending around the extensible member 134 adjacent the axial end thereof. A retainer clip 204 holds the bumper 202 in place on the axial end of the extensible member 134. The retainer clip 204 may include any suitable hardware including, for example, a washer, a nut, a cotter pin, an E-Clip, or a C-clip such as a snap ring.

FIG. 13B illustrates cut-away view of the EM brake 146 of the powered actuator according to aspects of the disclosure. The EM brake 146 is coupled to the driven shaft 166 and configured to apply a braking force to oppose rotation of the driven shaft 166. Specifically, the EM brake 146 includes a cup-shaped inner housing 206 at least partially disposed within a cup-shaped outer housing 208. An armature plate 210 is fixed to rotate with the driven shaft 166, and a fixed plate 212 is fixed to the outer housing 208 and prevented from rotating. An annular band 214 of friction material is fixed to the armature plate 210 adjacent to the fixed plate 212. The EM brake 146 includes a solenoid coil 216 disposed within the inner housing 206 and configured to be energized by an electrical current for causing the armature plate 210 to move away from the fixed plate 212. A coil spring 218 extends through a central bore of the inner housing 206 and biases the armature plate 210 toward the fixed plate 212. A detailed description of the EM brake 146 and its operation are provided in applicant's U.S. Pat. No. 10,280,674, which is hereby incorporated by reference in its entirety.

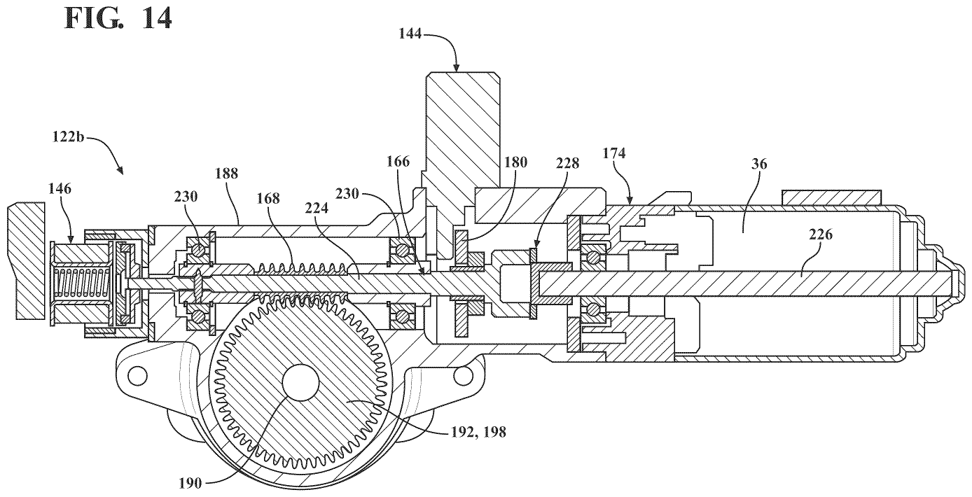

FIG. 14 illustrates a cut-away view of a third powered actuator 122b according to aspects of the disclosure. Specifically, the plane of the cut-away view shown in FIG. 14 extends through the driven shaft and a plane of the worm wheel 198. As shown in FIG. 14, the driven shaft 166 comprises a gearbox input shaft 224 that is coupled to a motor shaft 226 of the electric motor 36 via a coupling 228. The coupling 228 may be a fixed coupling, such as a splined connection, causing the gearbox input shaft 224 to rotate with the motor shaft 226. In some embodiments, the coupling 228 may be a flex coupling, allowing some degree of relative rotation between the gearbox input shaft 224 and the motor shaft 226. In some embodiments, the coupling 228 may include a clutch for selectively fixing the gearbox input shaft 224 to rotate with the motor shaft 226. A set of input bearings 230 holds the gearbox input shaft 224 on either side of the worm gear 168. Either or both of the input bearings 230 may be any type of bearing, such as a ball bearing, a roller bearing, etc.

In some embodiments, and as shown in FIG. 14, the torque tube 192 and the worm wheel 198 are formed as an integrated unit, with gear teeth formed on an outer perimeter, and with the lead nut 190 formed on an inner bore. In some embodiments, the torque tube 192 and the worm wheel 198 are formed as an integrated unit, and the lead nut 190 is a separate piece that is fixed to rotate therewith.

The third powered actuator 122b shown in FIG. 14 includes the EM brake 146 spaced away from the high-resolution position sensor 144, with the gearbox 140 disposed therebetween.

FIG. 15 illustrates a cut-away view of a fourth powered actuator 122c according to aspects of the disclosure. Specifically, the fourth powered actuator 122c is similar to the third powered actuator 122b shown in FIG. 14, in which the coupling 228 includes a clutch for selectively fixing the gearbox input shaft 224 to rotate with the motor shaft 226. In this case, the magnet wheel 180 is fixed to rotate with the gearbox input shaft 224, thus providing an indication of the extensible member 134 and the vehicle door coupled thereto. In all configurations of the powered actuator 122 described herein, the power actuator 122 may be configured without a clutch, having a permanent coupling between the motor 26 and the extensible member 134 connection with the vehicle body 14.

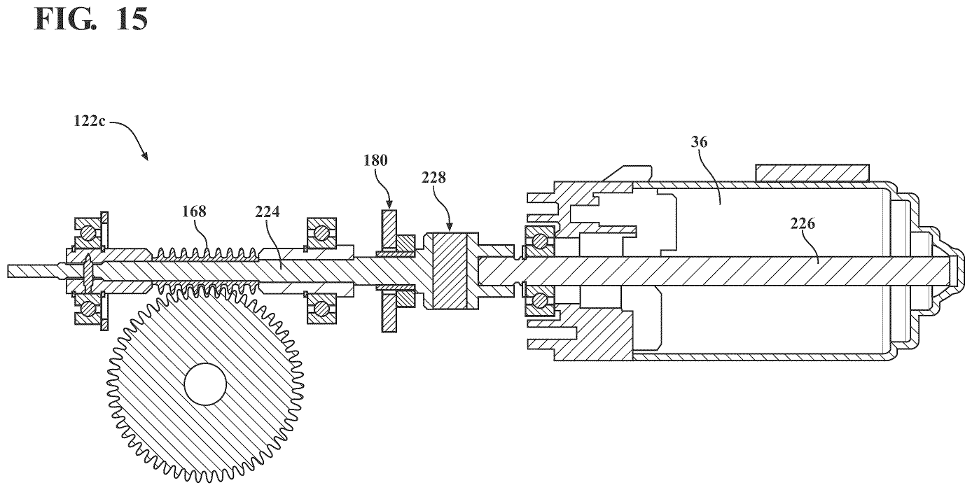

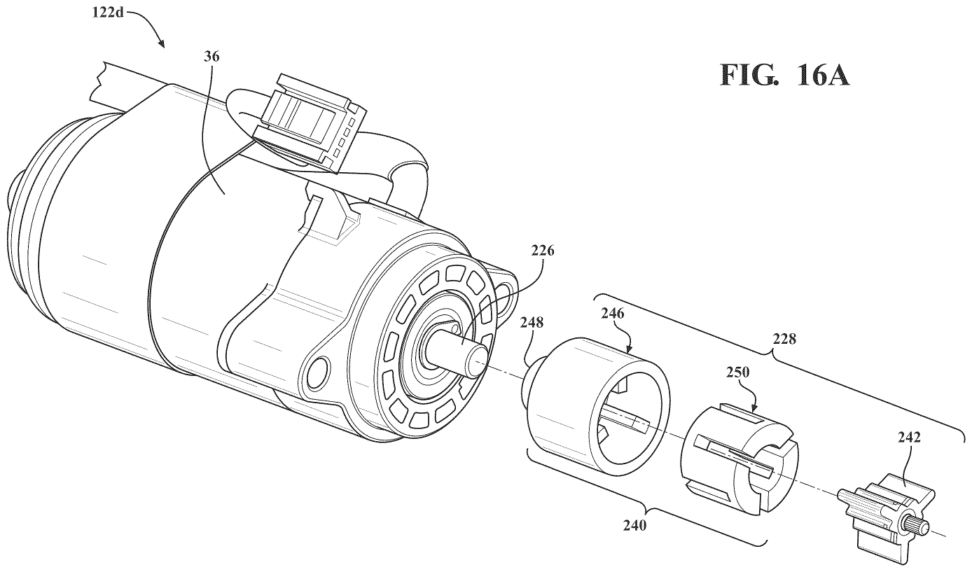

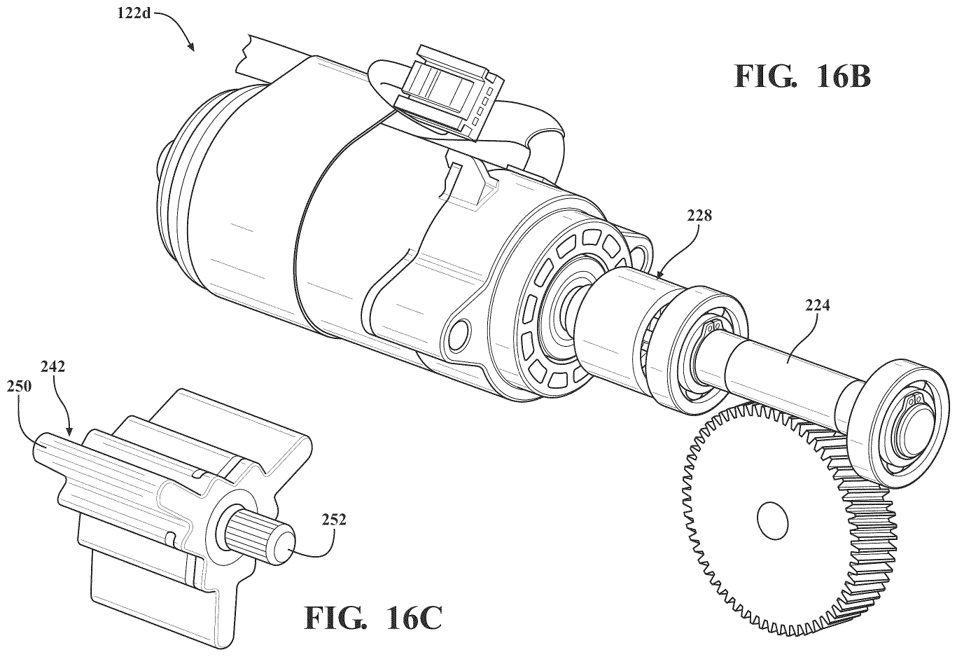

FIGS. 16A-16B show an electric motor 36 and coupling 228 of a fifth powered actuator 122d according to aspects of the disclosure. Specifically, FIG. 16A shows an exploded view of the coupling 228 which includes a flex coupling 240 and a slip device 242. The flex coupling 240 couples the motor shaft 226 of the electric motor 36 to the slip device 242 and allows some limited rotation therebetween. The flex coupling 240 may, for example, transmit driving torque from the motor shaft 226 to the slip device 242 while limiting the transmission of vibration therebetween. The flex coupling 240 shown in FIG. 16A includes an input member 246 having a cup-shape extending from a base 248 that is configured to rotate with the motor shaft 226. The base 248 may be keyed or splined or otherwise fixed to rotate with the motor shaft 226. The input member 246 is configured to turn the slip device 242, with an output member 250 of resilient material, such as rubber, disposed between the input member 246 and the slip device 242 for allowing some degree of rotation therebetween. As shown in FIG. 16C, the slip device 242 includes a triangular body 250 surrounding a shaft stub 252 that is splined and coupled to turn the gearbox input shaft 224. The slip device 242 is configured to provide some slip, or relative rotation between the input member 246 and the gearbox input shaft 224 if a torque therebetween exceeds a predetermined value.

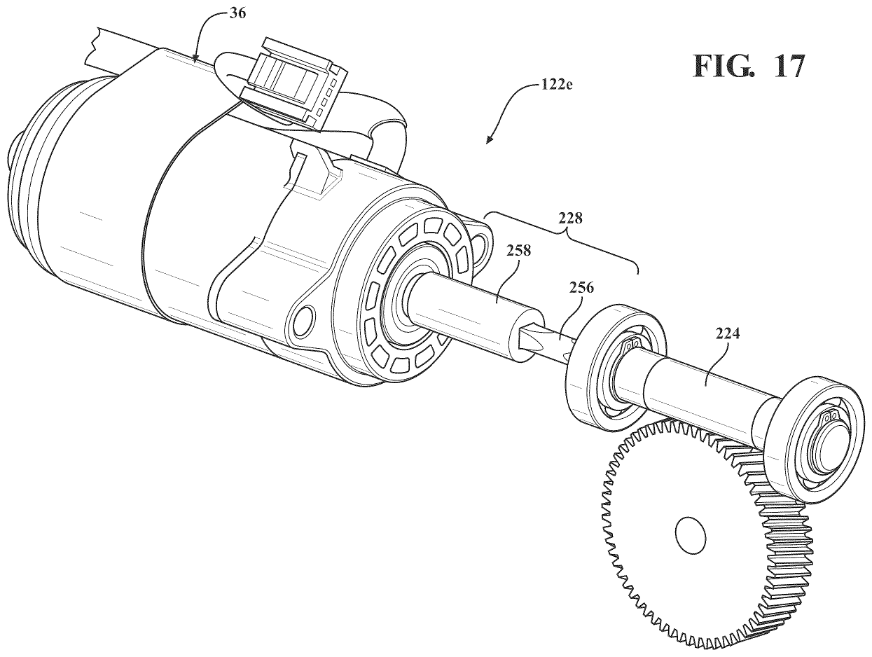

FIG. 17 shows an electric motor 36 and coupling 228 of a sixth powered actuator 122e according to aspects of the disclosure. Specifically, the coupling 228 shown in FIG. 17 includes a flex shaft 256 that is configured to twist by a predetermined amount in response to application of torque between two opposite ends thereof. One end of the flex shaft 256 is coupled to the gearbox input shaft 224, and the other end of the flex shaft 256 is coupled to the motor shaft 226 of the electric motor 36 via a shaft adapter 258. The shaft adapter 258 may be keyed or splined or otherwise fixed to rotate with the motor shaft 226. Thus, the flex shaft 256 provides for rotational flex between the motor shaft 226 and the gearbox input shaft 224.

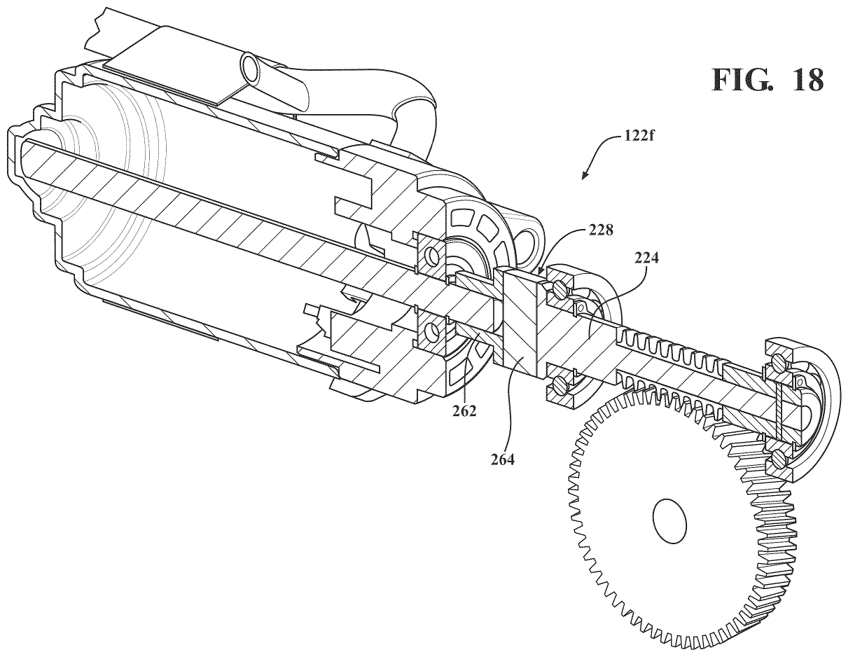

FIG. 18 shows an electric motor 36 and coupling 228 of a seventh powered actuator 122f according to aspects of the disclosure. Specifically, the coupling 228 shown in FIG. 18 is a flex coupling, which may be a high-speed flex coupling, which may be available off the shelf. The coupling 228 includes an input adapter 262 that is coupled to the motor shaft 226 of the electric motor 36. The input adapter 262 may be keyed or splined or otherwise fixed to rotate with the motor shaft 226. The coupling 228 also includes a resilient layer 264 of a resilient material, such as rubber, which is fixed to rotate with the input adapter 262 and which is also fixed to turn the gearbox input shaft 224. The coupling 228, thus functions as a flex coupling, allowing some limited relative rotation, less than one rotation, between the motor shaft 226 the gearbox input shaft 224. The seventh powered actuator 122f does not include any slip device and does not provide for any relative rotation between the motor shaft 226 the gearbox input shaft 224 beyond what is provided by the resilient layer 264 of the coupling 228.

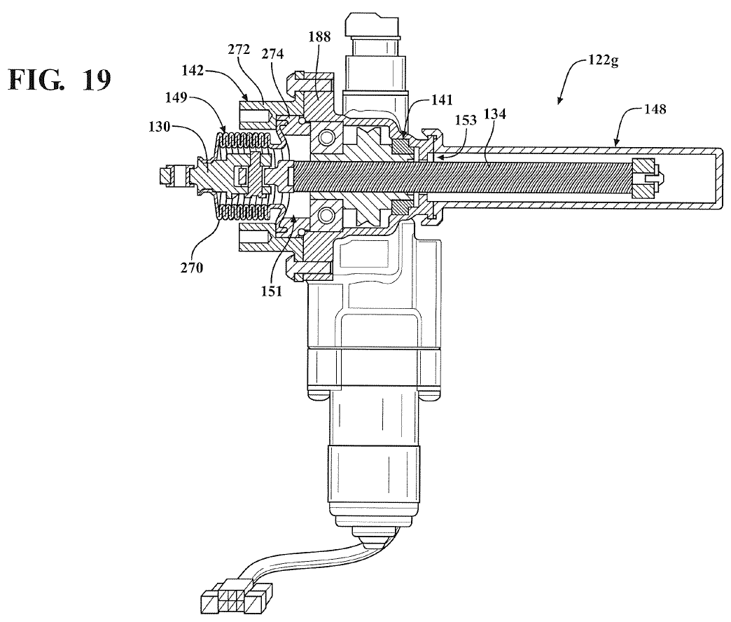

FIG. 19 shows an eighth powered actuator 122g according to aspects of the disclosure. The eighth powered actuator 122g may be similar or identical to other powered actuators disclosed herein, but with some additional protective equipment. Specifically, a boot 270 is configured to cover the extensible member 134 and to move with the extensible member 134 as it extends out of the adapter 142. The boot 270 may have a tubular and ribbed construction, similar to a covering of a shock absorber, to prevent contaminants from contacting the extensible member 134. The boot 270 may also prevent wires or other items from being caught in the extensible member 134 as it extends or retracts from the adapter 142. One end of the boot 270 (for example an outer end) is fixed to the link bar 130, and the other end of the boot 270 (for example an inner end) is fixed to the adapter 142. In some embodiments, and as shown in FIG. 19, the adapter 142 is a two-piece design, including an outer member 272 receiving and surrounding an inner member 274, with the boot 270 (in particular the inner end) sandwiched therebetween. As the extensible member 134 extends outward from the adapter 142, the boot 270 will lengthen and extend away from the adapter 142. The inner and outer members 272, 274 may be held together by the screws or bolts that hold the adapter 142 to the gearbox housing 188.

FIG. 20 illustrates a schematic block diagram of components within a powered actuator having a first configuration 22a according to aspects of the disclosure. Specifically, FIG. 20 shows the magnet wheel 180 being spaced apart from the EM brake 146 by a direct drive coupling (e.g. the worm gear 168), thus reducing or eliminating electromagnetic interference (i.e. the EM Brake Field 146a) from interfering with the high-resolution position sensor. More specifically, the first configuration 22a includes the EM brake 146, the direct drive coupling (168), the magnet wheel 180, and the electric motor 36 are all disposed along the driven shaft 166 in that given order.

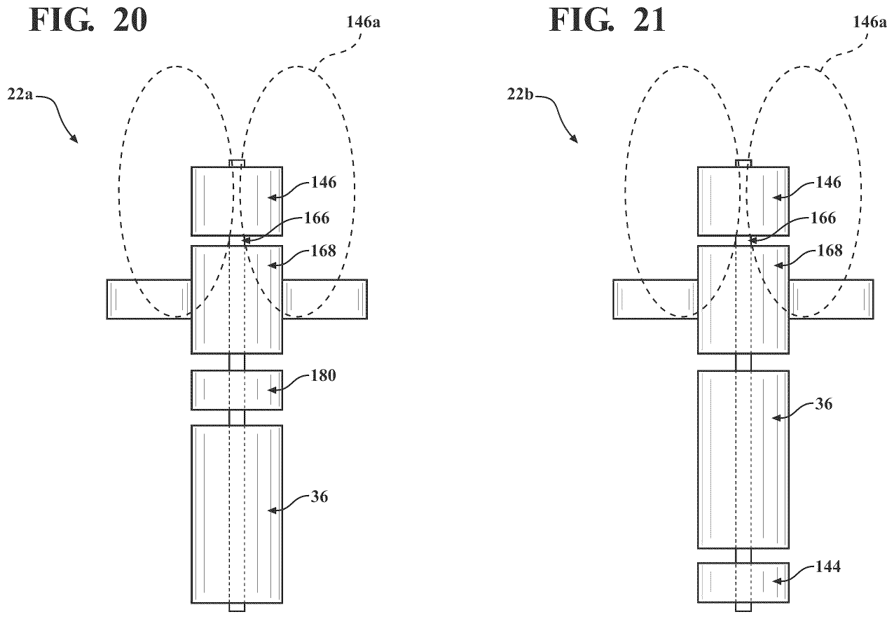

FIG. 21 illustrates a schematic block diagram of components within a powered actuator having a second configuration 22b according to aspects of the disclosure. Specifically, FIG. 21 shows the magnet wheel 180 being spaced apart from the EM brake 146 by the electric motor 36 and the direct drive coupling (e.g. the worm gear 168), thus reducing or eliminating electromagnetic interference from interfering with the high-resolution position sensor. More specifically, the second configuration 22b includes the EM brake 146, the direct drive coupling (worm gear 168), the electric motor 36, and the magnet wheel 180 all disposed along the driven shaft 166 in that given order.

In each of the above configurations 22a and 22b, the magnet wheel 180 is disposed outside of the electromagnetic field of the EM brake 146. In each of the above cases, the worm gear 168 is disposed adjacent the EM brake 146 and overlaps with the magnetic field of the EM brake 146. The worm gear 168 is generally not susceptible to interference caused by the EM brake 146.

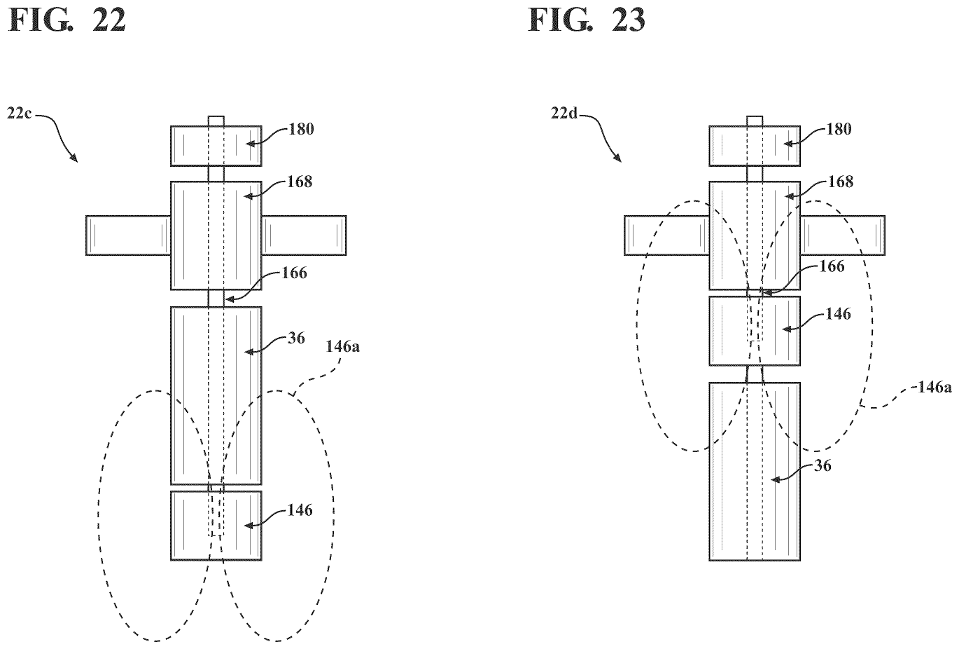

FIG. 22 illustrates a schematic block diagram of components within a powered actuator having a third configuration 22c according to aspects of the disclosure. Specifically, FIG. 22 shows the magnet wheel 180 being spaced apart from the EM brake 146 by the electric motor 36 and the direct drive coupling (e.g. the worm gear 168), thus reducing or eliminating electromagnetic interference from interfering with the high-resolution position sensor. More specifically, the third configuration 22c includes the magnet wheel 180, the direct drive coupling (168), the electric motor 36, and the EM brake 146 all disposed along the driven shaft 166 in that given order.

FIG. 23 illustrates a schematic block diagram of components within a powered actuator in a fourth configuration 22d according to aspects of the disclosure. Specifically, FIG. 23 shows the magnet wheel 180 being spaced apart from the EM brake 146 by the direct drive coupling (e.g. the worm gear 168), thus reducing or eliminating electromagnetic interference from interfering with the high-resolution position sensor. More specifically, the fourth configuration 22d includes the magnet wheel 180, the direct drive coupling (168), the EM brake 146, and the electric motor 36 all disposed along the driven shaft 166 in that given order.

In each of the above configurations 22c and 22d, the motor 36 is partially disposed within the magnetic field of the EM brake 146. The magnet wheel 180, similar to configurations 22a and 22b, is disposed outside of the magnetic field of the EM brake 146. In each of configurations 22c and 22d, the magnet wheel is shown adjacent the worm gear 168, and the EM brake 146 is adjacent the motor 36.

It will be appreciated that the configurations 22a-d include a variety of similarities and differences shared among two or more configurations. However, in each configuration, the magnet wheel 180 is positioned relative to the EM brake 146, based on the stackup of components, such that the magnet wheel 180 is outside of the magnetic field of the EM brake 146. The amount of spacing may vary depending on the stackup of components, as shown in FIGS. 20-23.

In another aspect, an electromagnetic shield, in the form of a cover or coating, may be applied between or on the magnet wheel 180 and the EM brake 146 to block the magnetic field of the EM brake 146 and reduce potential interference.

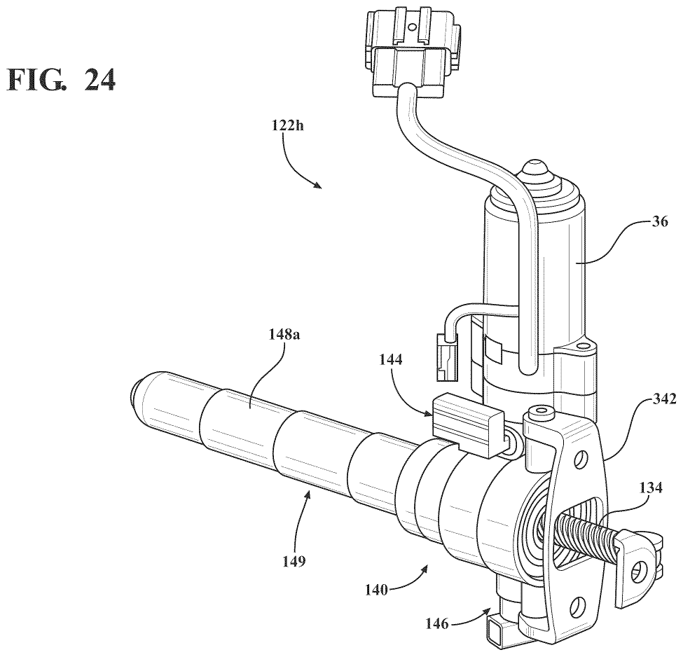

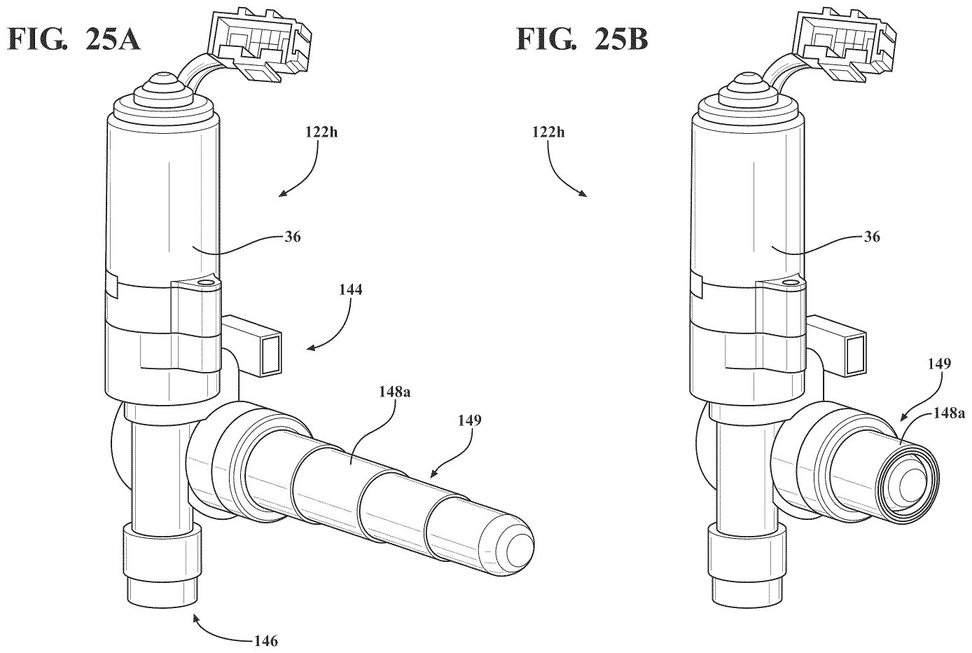

FIGS. 24 and 25A-25B illustrate a ninth powered actuator 122h according to aspects of the disclosure. Specifically, the ninth powered actuator includes a retractable dust shield 148a enclosing the extensible member 134. The retractable dust shield 148a has a telescopic design including a plurality of tubular segments configured to move between an expanded state shown in FIG. 25A and a compressed state shown in FIG. 25B. FIG. 24 further illustrates motor 36, high resolution position sensor 144 for haptic control, EM brake 146, gearbox 140, etc.

FIG. 24 generally corresponds to FIG. 25A, wherein the extensible member 134 or leadscrew is in a retracted position in a door closed state, similar to the position shown in FIGS. 19, 12A, and 13A. FIG. 25B illustrates an extended position of the extensible member 134 in a door open state. Thus, the telescoping dust shield 148a is compressed retracted when the extensible member 134 is extended, and the dust shield 148a is extended when the extensible member is retracted. The overall length of the telescoping dust shield 148a changes in response to shifting of the extensible member 134.

FIG. 24 illustrates further aspects of the disclosure. FIG. 24 further illustrates a door adapter bracket 342 configured to allow for easy adaptation to various environments. The bracket 342 is operable to eliminate or substantially reduce moment variations due to a linkage between the vehicle body (or closure body) and the end of the extensible member 134 (for example a leadscrew). This arrangement provides enhanced haptic/servo control response. For example, the moment arm generally does not vary at different door positions. Accordingly, a linkage need not be accommodated, and the actuator 122h may be brought closer towards the shut face of the closure 12 (or vehicle body 14), thereby improving assembly requirements and reducing the space occupied within the door cavity (or vehicle body cavity). The motor 36, magnet ring 180, EM brake 145, etc. described above, as well as other components described above, may be used in the actuator 122h, similar to the previously described actuators.

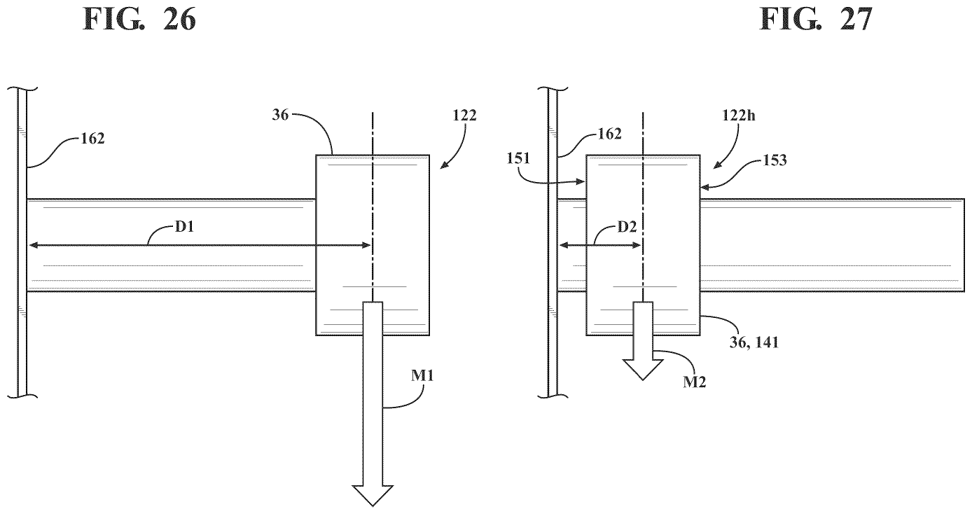

FIG. 26 illustrates a schematic diagram of components of a powered actuator 122, where the motor 36 is disposed further from the shut face 162 a distance D1, such as for actuators having a linkage. As illustrated in FIG. 26, there is distance D1 between the motor 36 and the shut face 162. Due to the distance, a relatively large amount of loading (M1) may arise on the sheet metal of the shut face 162 due to the weight of the actuator (in particular the center of mass) distal from the mounting point of the actuator 122 to the sheet metal of the shut face 162.

FIG. 27 illustrates a schematic diagram of components of an improved powered actuator according to aspects of the disclosure, such as actuator 122h described above. Specifically, FIG. 27 illustrates the powered actuator 122h of the present disclosure that moves weight, in particular the center of mass, (e.g. the motor 36 and other components attached thereto, such as gearbox housing 141) closer to the mounting point of the actuator 122h (distance D2) to the shut face 162. The powered actuator design according to an aspect of the present disclosure may, therefore, reduce loads on mounting points and surrounding sheet metal of the shut face. The actuator 122h may operate without a linkage, thereby allowing the motor 36 to be moved closer to the shut face 162 and reduce the load (M2) on the sheet metal.

Both FIGS. 26 and 27 combine to illustrate how aperture 151 and 153 on each side of gearbox housing 141 are closer to the shut face 162 in FIG. 27. The extensible member 134 shifts relative to gearbox housing in and out of apertures 151 and 153. It will be appreciated that the illustrations of FIGS. 26 and 27 are schematic and intended to illustrate the reduced spacing and loading resulting from the arrangement of FIG. 27.

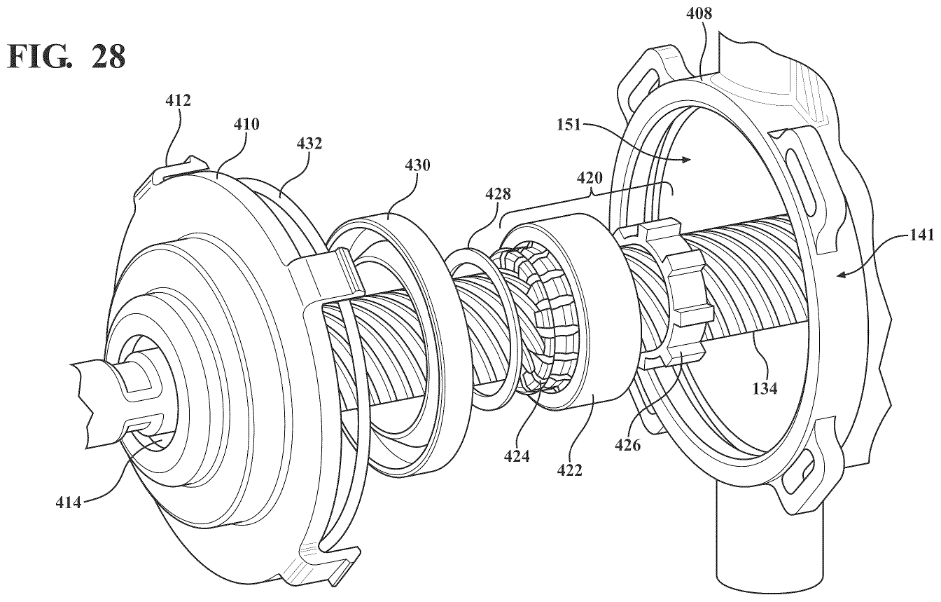

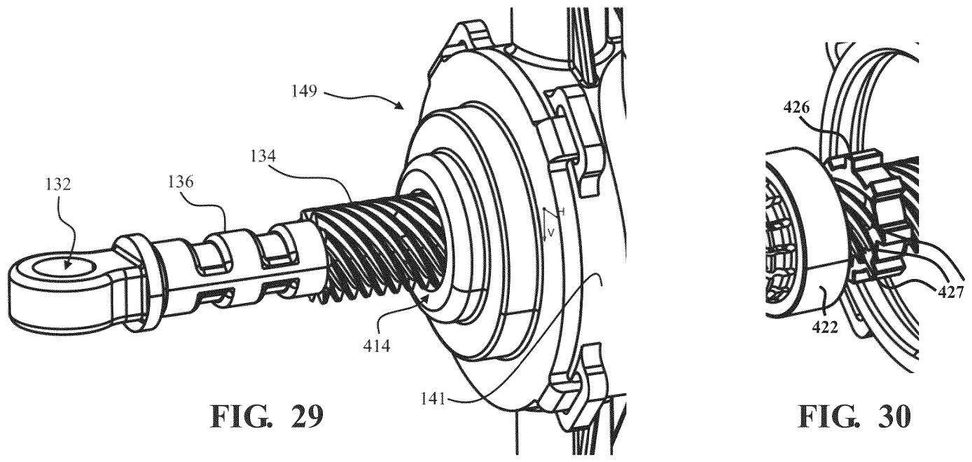

FIG. 28 illustrates another power actuator 122i in accordance with an aspect of the disclosure. In this aspect, the side of the power actuator 122i that includes the exposed portion of the extensible member 134 (in the form of a leadscrew), for example when the extensible member 134 has been actuated and extended, may include a sealing arrangement to prevent fouling of the extensible member 134 due to debris, water, or the like.

As shown in the exploded perspective view of FIG. 28, power actuator 122i may include an outer housing 408 (which may be the adapter 142, gearbox 140, or other housing structure where the extensible member 134 extends from when actuated) and may further include a cover 410. The cover 410 is sized and arranged to selectively mount to and couple with an actuator housing 408. In one aspect, the cover 410 may include a plurality of projecting snap-fit tabs 412 sized and arranged to be received in corresponding receptacles formed on the housing 408. As shown, there are four tabs 412 equally spaced circumferentially around the circular shaped cover 410. It will be appreciated that other spacing and quantities may be used. Similarly, other securing arrangements may be used to secure the cover 410 to the adapter 142. The cover 410 may define an opening 414 through which the extensible member 134 may project when it moves axially.

Inside of the cover 410 are a plurality of sealing and scraping implements for blocking and/or removing debris, and for further limiting ingress of water, dust, or other microparticles.

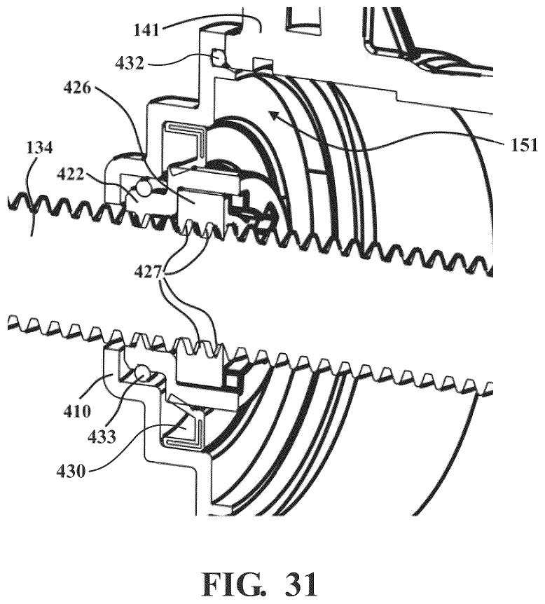

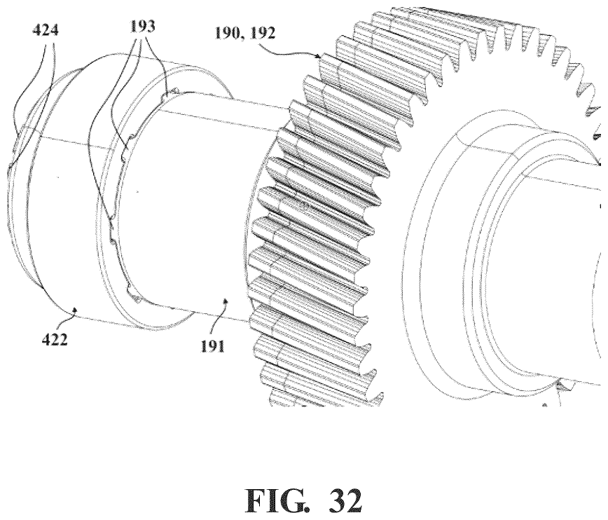

In one aspect, a scraper assembly 420 is provided and disposed inside of the cover 410. The scraper assembly 420 may include a scraper housing 422. The scraper housing 422 may have a generally cylindrical shape and may be fixed for rotation with lead nut 190, for example via a hollow cylindrical coupling 191 for example connecting the scraper housing 422 with the lead nut 190 as seen in FIG. 32. Accordingly, as the lead nut 190 rotates, the scraper housing 422 also rotates. Rotation of the scraper housing 422 occurs while the extensible member 134 translates linearly, such that the threads of the leadscrew 134 pass through the scraper housing 422, without the threads being caused to lock in engagement with the scraper housing 420 in a configuration where the scraper assembly 420 is not configured to rotate, either independently, or dependently such as by a coupling with the lead nut 190 as shown in FIG. 32. Coupling 191 may engage with the scraper housing 422 or lead nut 190 (not shown) via a series of teeth 193 received within apertures formed in the scraper housing 422 or nut 190. A scraper tooth 424 is fixed to the scraper housing 422. In one aspect, the scraper tooth may be integrally formed with the housing 422. The scraper tooth 424 is sized and arranged to fit within the thread profile of the extensible member 134, as shown in the cross-section of FIG. 31. As the leadscrew is drawn back into the actuator 122i, debris or other matter disposed within the grooves of the threads of the leadscrew will be blocked by the scraper tooth 424 such that the debris does not continue into the actuator 122i along with the extensible member 134.

The scraper tooth 424 has a generally annular or ring-shape corresponding to the shape of the scraper housing 422. A scraper seal member 426 is disposed inside of the scraper housing 422. The seal member 426 has an annular shape and may be fixed for rotation with the scraper housing 422, such that it rotates with the scraper housing 422. Scraper seal member 426 includes a threaded inner surface 427 for mating with the threads of leadscrew 134, as shown in more detail in FIG. 30 and FIG. 31.

A first compression ring 428, having a first diameter, is disposed adjacent the scraper assembly 420. A second compression ring 430, having a second diameter greater than the first diameter, is disposed radially between the cover 410 and the scraper assembly 420 (as shown in FIG. 31). An O-ring seal member 432, having a third diameter greater than the first and second diameter, is disposed axially between the cover 410 and the gearbox housing 141, as shown in FIG. 31. Another O-ring seal member 433 is disposed radially between the scraper housing 422 and the cover 410, as shown in FIG. 31.

As shown in FIG. 31, the cover 410 may have a stepped cross-sectional profile, and the scraper housing 422 (having scraper tooth 424) may have a similar stepped shape to fit within the cover 410. The O-ring 433 can fit radially between the respective stepped portions of the cover 410 and the scraper housing 422. The second compression ring 430 is shown in FIG. 31 and is disposed axially inward relative to the O-ring 433 and is disposed radially between the scraper housing 422 and another stepped portion of the cover 410.

Given the above O-rings and compression rings, and seal members, the scraper assembly 420 is therefore sealed against the cover 410. The cover 410 is sealed against gearbox housing 141. And the extensible member 134 is sealed against the scraper assembly 420. Accordingly, the extensible member 134 is sealed relative to the gearbox housing via the scraper assembly 420 and the cover 410.

Thus, when the cover 410 is secured to the adapter, the O-ring seal member 432 will be compressed therebetween to provide a sealing function. The cover 410 still includes hole or opening 414 for allowing the extensible member 134 to project outwardly therefrom. Accordingly, debris may enter the inside of the cover 410. However, when assembled, the scraper assembly 420 is disposed near the opening 414. Of course, when the extensible member 134 is extended and exposed outwardly from the cover 410, debris may accumulate on its surface. The debris is scraped and blocked during retraction of the leadscrew by the scraper assembly 420, which also seals the interior of the actuator 122i as described above.

There is therefore illustratively shown herein a powered actuator for a closure of a vehicle including an electric motor 136 configured to rotate a driven shaft 166, an extensible member 134, such as a leadscrew configured to be coupled to one of a body 14 or the closure 12 of the vehicle for opening or closing the closure 12, a gearbox 140 comprising a gearbox housing 141, the gearbox 140 configured to apply a force to the extensible member 134 for causing the extensible member 134 to move linearly in response to rotation of the driven shaft 166, and at least one sealing assembly 149 configured to seal the gearbox housing 141 as the extensible member translates linearly. The gearbox housing 141 may include at least one aperture for allowing the extensible member to pass through as the extensible member translates linearly. The at least one aperture may include a first aperture 151 facing the shut face 162 of the closure 12 and a second aperture 153 facing an inner cavity 39 of the closure 12 such that the extensible member 134 passes through both the first aperture 151 and the second aperture 153 as the extensible member 134 translates linearly within the housing 141. One of the at least one sealing assembly 149 may be associated with the first aperture 151 (see FIGS. 19 and 28 for example) and another one of the at least one sealing assembly is associated with the second aperture 153 (see FIG. 25A and FIG. 25B for example). The at least one sealing assembly 149 associated with the first aperture 151 may be configured to abut against the extensible member 134 to allow the extensible member to translate linearly through the at least one sealing assembly (see FIG. 28), while also provided a seal between the extensible member 134 and the housing 141. Therefore the extensible member 134 may leave the interior sealed space of the housing 141 such that part of the extensible member 134 may be exposed to the external environment upon extension of the extensible member 134, as shown in FIG. 24 for example. The at least one sealing assembly associated with the first aperture may be configured as the scraper assembly 420 configured to remove debris from the extensible member as the extensible member translates linearly from the extended position to the retracted position. Therefore any debris, dust, dirt and the like deposited on the part of the extensible member 134 exposed to the external environment when the extensible member 134 is in the extended position may be prevented from entering into the internal cavity of the housing 141 when the extensible member 134 is retracted. Because the extensible member 134 is configured for reciprocation relative to the gearbox housing 141 as provided for by apertures 151, 153 disposed on opposite sides of the housing 141 such that portions of the extensible member 134 extending beyond the apertures 151, 153 would be exposed to the external environment (for example, the leadscrew 134 is not completely encompassed by a housing, such as two overlapping tubes which remain in overlapping sealing configuration when extended or retracted relative to each other such that the leadscrew never extends outside the encompassment of the tubes) but for either the least one sealing assembly 149 as a cover preventing the contact of debris, dirt, or like contaminating particles from entering into contact with the extensible member 134 when the extensible member 134 is extending beyond the apertures 151, 153, or the least one sealing assembly 149 as a wiper or scrapper configuration removing debris, dirt, or like contaminating particles by abutting contact (e.g. in abutment) having entered into contact with the extensible member 134. Scraper assembly 420 may also be associated with the second aperture 153 in a similar manner. The another one of the at least one sealing assembly associated with the second aperture 153 may be configured to extend and retract with the extensible member 134 as the extensible member 134 translates linearly through the second aperture 153. The another one of the at least one sealing assembly associated with the second aperture 153 may be configured as a cover 148, such as a boot, configured to encompass of fully expose the extensible member 134 as the extensible member translates linearly through the second aperture 153. The another one of the at least one sealing assembly associated with the second aperture 153 may be an expandable/collapsible cover 148 or boot configured to encompass the extensible member as the extensible member translates linearly through the second aperture 153, and the gearbox 140 may include a lead nut 190, 192 rotatable in response to rotation by the driven shaft 166, and the extensible member 134 may include a leadscrew configured to move axially in response to rotation of the lead nut 190. The powered actuator may further be configured with an adapter 142, 342 configured to mount the gearbox 140 to a shut face 162 of the closure 12. The powered actuator may further include a high-resolution position sensor 144 coupled to the driven shaft 166 and configured to detect a position of the driven shaft 166 and transmit the position to a servo controller, such as controller 50.

Clearly, changes may be made to what is described and illustrated herein without, however, departing from the scope defined in the accompanying claims. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present disclosure provides a number of example embodiments of vehicle exterior components that are configured to hold one or more parts of a radar sensor, and which addresses the constraints of limited space and management of heat that is generated by operation of the radar sensor. In some embodiments, the radar sensor includes parts having a maximum operating temperature of 125 degrees C. at an ambient temperature of 80 degrees C. The present disclosure also provides example embodiments that provide water resistance to prevent the radar sensor from being adversely affected by exposure to moisture.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A powered actuator for a closure of a vehicle, comprising:
an electric motor configured to rotate a driven shaft;
an extensible member configured to be coupled to one of a body or the closure of the vehicle for opening or closing the closure;
a gearbox comprising a gearbox housing, the gearbox configured to apply a force to the extensible member for causing the extensible member to move linearly in response to rotation of the driven shaft; and
at least one sealing assembly configured to seal the gearbox housing and fully encompass a part of the extensible member that translates linearly away from and outside of the gearbox;
wherein the gearbox includes a lead nut rotatable in response to rotation by the driven shaft, and wherein the extensible member comprises a leadscrew configured to move axially in response to rotation of the lead nut;
wherein the leadscrew comprises a first end configured to be coupled to a body of the vehicle and an opposite second end, and the gearbox comprises a first side and an opposite second side, wherein the at least one sealing assembly comprises a first sealing assembly that is connected to the first end of the leadscrew and to the first side of the gearbox to fully enclose the part of the leadscrew that is fully extended outside of the gearbox on the first side of the gearbox;
wherein the at least one sealing assembly comprises a second sealing assembly that is connected to the opposite second end of the leadscrew and to the second side of the gearbox to fully enclose the part of the leadscrew that is fully extended outside of the gearbox on the second side of the gearbox.

2. The powered actuator of claim 1, wherein the gearbox housing comprises at least one aperture for allowing the extensible member to pass through as the extensible member translates linearly.

3. The powered actuator of claim 2, wherein the at least one aperture comprises a first aperture facing a shut face of the closure and a second aperture facing an inner cavity of the closure, wherein the extensible member passes through both the first aperture and the second aperture as the extensible member reciprocates through the gearbox housing.

4. The powered actuator of claim 3, wherein the first sealing assembly is adapted to change in length as the extensible member reciprocates through the gearbox housing.

5. The powered actuator of claim 4, wherein the first sealing assembly is associated with the first aperture and is fixed to the extensible member to allow the first sealing assembly to move with the extensible member as the extensible member translates linearly through the at least one aperture.

6. The powered actuator of claim 4, wherein the second sealing assembly is associated with the second aperture and is not fixed to the extensible member to allow the extensible member to translate linearly through the at least one sealing assembly without the second sealing assembly collapsing.

7. The powered actuator of claim 4, wherein the first sealing assembly comprises ribs.

8. The powered actuator of claim 7, wherein the second sealing assembly is associated with the second aperture and is a collapsible cover configured to encompass the extensible member as the extensible member translates linearly through the second aperture.

9. The powered actuator of claim 6, wherein the second sealing assembly is a hollow cylindrical tube.

10. The powered actuator of claim 1, further comprising an adapter configured to mount the gearbox to a shut face of the closure.

11. The powered actuator of claim 1, further comprising a high-resolution position sensor coupled to the driven shaft and configured to detect a position of the driven shaft and transmit the position to a servo control system.

12. The powered actuator of claim 1, wherein the leadscrew itself is the extensible member that translates linearly and extends out from the gearbox housing in response to rotation of the lead nut driven by the motor, wherein the leadscrew comprises a first end configured to be coupled to a body of the vehicle via a pivot connection and also comprises an opposite second end, and the gearbox comprises a first side and an opposite second side, wherein the first sealing assembly is connected to a linkage connected to the first end of the leadscrew and to the first side of the gearbox to fully enclose the part of the leadscrew that extends outside of the gearbox.

13. The powered actuator of claim 12, wherein the linkage comprises a hole for receiving a pin for facilitating pivotal connection of the linkage to the body of the vehicle.

14. A powered actuator for a closure of a vehicle, comprising:
an electric motor configured to rotate a driven shaft;
an extensible member configured to be coupled to one of a body or the closure of the vehicle for opening or closing the closure;
a gearbox comprising a gearbox housing, the gearbox configured to apply a force to the extensible member for causing the extensible member to move linearly in response to rotation of the driven shaft; and
at least one sealing assembly configured to seal the gearbox housing as the extensible member translates linearly;
wherein the gearbox housing has opposite first and second sides and respective first and second apertures at the first and second sides, wherein the extensible member extends out of the first and second apertures of the gearbox housing;
wherein the at least one sealing assembly fully encompasses a part of the extensible member that translates away from and outside of the gearbox;
wherein the extensible member comprises a first end configured to be coupled to the body or the closure of the vehicle and an opposite second end, wherein the at least one sealing assembly comprises a first sealing assembly that is connected to the first end of the extensible member and to the first side of the gearbox housing to fully enclose the part of the leadscrew that extends outside of the gearbox on the first side of the gearbox housing with the door in the open position;
wherein the at least one sealing assembly comprises a second sealing assembly that is connected to the opposite second end of the extensible member and to the second side of the gearbox to fully enclose the part of the leadscrew that extends outside of the gearbox on the second side of the gearbox housing.

15. The powered actuator of claim 14, wherein the first aperture faces a shut face of the closure and the second aperture faces away from the shut face, wherein the first sealing assembly is connected to the first end of the leadscrew and is configured to change in length as the extensible member reciprocates relative to the first and second apertures while extending out of the first and second apertures.

16. The powered actuator of claim 15, wherein second sealing assembly is a hollow cylindrical tube that is not connected to the extensible member.

17. A powered actuator for a closure of a vehicle, comprising:
an electric motor configured to rotate a driven shaft;
an extensible member configured to be coupled to one of a body or the closure of the vehicle for opening or closing the closure;
a gearbox comprising a gearbox housing, the gearbox configured to apply a force to the extensible member for causing the extensible member to move linearly in response to rotation of the driven shaft wherein the gearbox housing includes a first aperture on a first side of the gearbox housing facing a shut face of the closure and a second aperture on the opposite side of the gearbox housing;
a first sealing assembly having first and second ends, connected at the first end to the extensible member and at the second end to the gearbox housing configured to fully encompass a part of the extensible member that translates linearly away from and towards the gearbox to seal the gearbox housing as the extensible member translates linearly, wherein the first sealing member expands and contracts such that a length between the first and second ends varies in response to translation of the extensible member; and
a second sealing assembly as a hollow tube having a first open end connected to the gearbox housing and a second closed end disconnected from the extensible member, wherein the first sealing assembly and the second sealing assembly fully encompass the extensible member as the extensible member translates linearly away from and towards the gearbox.

18. The powered actuator of claim 17, wherein the extensible member is a leadscrew that comprises a travel limiter that is configured to abut the opposite side of the gearbox housing to limit the extension of the extensible member away from the first side.

19. The powered actuator of claim 18, wherein the travel limiter is disposed at an axial end of the extensible member and the travel limiter is a bumper made of resilient material.

20. The powered actuator of claim 17, wherein the first sealing assembly has a ribbed construction.
